(19) United States
(12) Patent Application Publication
(10) Pub. No.: US 2017/0080378 A1
(43) Pub. Date: Mar. 23, 2017

(54) THERMALLY STABLE AMINES FOR CO2 CAPTURE

(71) Applicant: BOARD OF REGENTS, THE UNIVERSITY OF TEXAS SYSTEM, Austin, TX (US)

(72) Inventors: Gary Rochelle, Austin, TX (US); Yang Du, Austin, TX (US); Omkar Namjoshi, Baton Rouge, LA (US)

(21) Appl. No.: 15/367,404

(22) Filed: Dec. 2, 2016

Related U.S. Application Data
(63) Continuation of application No. PCT/US15/28539, filed on Apr. 30, 2015.
(60) Provisional application No. 62/006,627, filed on Jun. 2, 2014.

(51) Int. Cl. B01D 53/14; C10L 3/10; B01D 53/96; B01D 53/78; B01D 53/62

(52) U.S. Cl. CPC B01D 53/1493; B01D 53/1475; B01D 53/78; B01D 53/62; B01D 53/1425; B01D 53/96; C10L 3/102; B01D 2252/103; B01D 2252/2041; B01D 2252/20426; B01D 2252/20431; B01D 2252/20447; B01D 2252/20452; B01D 2252/20473; B01D 2252/504; B01D 2258/0283; C10L 2290/541

(57) ABSTRACT

A novel blend of piperazine (PZ) and a second amine compound is provided as a superior solvent for CO2 capture from coal-fired flue gas. Blending PZ with various second amine compounds can remediate the precipitation issue of concentrated PZ while maintaining its high CO2 absorption capacity and rate, and high resistance to oxidative degradation.

### CROSS-REFERENCE TO RELATED APPLICATIONS

This application is a continuation of International Application No. PCT/US15/28539, filed Apr. 30, 2015, which claims the benefit of U.S. Provisional Application No. 62/006,627, filed on Jun. 2, 2014, both of which are incorporated herein by reference in their entirety.

### BACKGROUND

The current industrial standard for amine scrubbing for effective capture of CO2 from coal-fired flue gas is 30 wt % monoethanolamine (MEA). A possible alternative to MEA is concentrated piperazine (PZ) which provides twice the CO2 absorption rate and CO2 capacity, and greater resistance to oxidative and thermal degradation than 30 wt % MEA, which can lower the heat duty for the stripper in amine scrubbing systems by approximately 5-10%. In spite of these desirable characteristics, the application of concentrated PZ in the industry may be limited by solid precipitation at both lean and rich CO2 loading. The present disclosure provides compositions and methods to alleviate the precipitation concerns associated with PZ without a concurrent reduction in its CO2 absorption rate and capacity, and resistance to degradation.

### SUMMARY

The present disclosure is directed to solvent compositions and methods for amine scrubbing. In one embodiment, an aqueous solvent is provided that comprises piperazine and a second amine compound. For example, the second amine compound can be selected from the group consisting of an imidazole or imidazole derivative, a tertiary morpholine, triethylenediamine (TDEA), and 4-hydroxy-1-methyl piperidine (HMPD). In the embodiments wherein the second amine compound is an imidazole or an imidazole derivative, the imidazole or imidazole derivative is selected from the group consisting of 2-ethylimidazole, 1-methylimidazole, 2-methylimidazole, 4-methylimidazole, 1,2-dimethylimidazole, 1-(3-Aminopropyl)imidazole, and 2-ethyl-4-methylimidazole.

In one embodiment, the second amine compound of the solvent is a tertiary morpholine. In this embodiment, the tertiary morpholine may comprise a hydroxyalkyl substituent group attached to a tertiary amino functional group. Furthermore, the hydroxyalkyl substituent group and tertiary amino functional group of the present embodiment may be separated by about two or three carbon atoms. For example, the tertiary morpholine can be selected from the group consisting of hydroxyethylmorpholine, hydroxypropylmorpholine, and hydroxyisopropylmorpholine.

In any of the above embodiments, piperazine and the second amine compound comprise about 10 to 60 wt % of the solvent and amine concentration is from about 4 to 12 equivalents/kg water of the solvent. In any of the above or below embodiments, the second amine compound may possess a molecular weight of less than 150 g/mol.

In any of the above embodiments, the solvent is free of precipitate at a CO2 loading of greater than 0.44 mol CO2/mol alkalinity.

In any of the above embodiments, the concentration of piperazine in the solvent can be from about 0.50 molal to about 7.00 molal and the concentration of the second amine compound is from about 1.00 molal to about 8.00 molal. For example, the concentration of piperazine and the second amine compound are each 2.5 molal, 3 molal, 4 molal or 5 molal. In any of the above embodiments, the solvent may possess a viscosity of about 3 cP to about 12 cP at a CO₂ loading of about 0.15 mol/mol alkalinity to about 0.3 mol/mol alkalinity, respectively, at a temperature of 40° C.

In any of the above embodiments, the solvent possesses a working capacity of 0.5 to 1.2 mol CO₂ per kg amines+water.

In any of the above embodiments, the solvent is free of solidification at 150° C. for at least 10 days when loaded with CO₂ at 0.2 mol/mol alkalinity.

In any of the above embodiments, the loss of piperazine and the second amine compound is 15% and 25%, respectively, at 150° C. for at least 10 days

In any of the above embodiments, the first order rate constant for thermal degradation of the piperazine component of the solvent at 150° C. to 165° C. with CO2 loading of 0.2 mol/mol alkalinity is from about 10 to about 850 k₁×10⁻⁹ (s⁻¹), from about 100 to about 500 k₁×10⁻⁹ (s⁻¹), and from about 150 to about 300 k₁×10⁻⁹ (s⁻¹), and any intermediate range therebetween. In this or any of the above embodiments, the first order rate constant for thermal degradation of the second amine component of the solvent at 150° C. to 165° C. with CO2 loading of 0.2 mol/mol alkalinity is from about 5 to about 750 k₁×10⁻⁹ (s⁻¹), from about 50 to about 550 k₁×10⁻⁹ (s⁻¹), from about 100 to about 400 k₁×10⁻⁹ (s⁻¹), and from about 150 to 350 k₁×10⁻⁹ (s⁻¹).

A method comprising contacting an acidic gas with an aqueous solvent of any of the above embodiments is provided. In one embodiment, the solvent is thermally regenerated in a single process column and/or process vessel or a series of process columns and/or process vessels at above atmospheric pressure and a temperature from about 120° C. to about 200° C., preferably from about 130° C. and 160° C., and more preferably between about 145° C. and 155° C. For example, the thermal regeneration may take place in a simple stripper, single-stage flash, two stage flash, or advanced flash stripper. The method can be applied on a number of sources of acidic gas including, but not limited to fossil fueled power plants, natural gas reservoirs, and industrial process gas sources.

### BRIEF DESCRIPTION OF THE DRAWINGS

The patent or application file contains at least one drawing executed in color. Copies of this patent or patent application publication with color drawings will be provided by the office upon request and payment of the necessary fee.

FIG. 1 provides a graph demonstrating the Liquid-Solid transition temperature for PZ/TEDA with the following amine ratios: 8 m PZ; 2 m-PZ/7 m-TEDA; 4 m-PZ/4 m-TEDA; 2.5 m-PZ/2.5 m-TEDA.

FIG. 2 depicts amine loss in 2.5 m PZ/2.5 m TEDA at 150 and 165° C. and 0.3 mol CO₂/mol alkalinity.

FIG. 3 depicts amine loss in 4 m PZ/4 m TEDA at 70° C. in the presence of O₂, as well as 0.1 mM Mn²⁺, 0.4 mM Fe²⁺, 0.05 mM Cr³⁺ and 0.1 mM Ni²⁺.

FIG. 4 provides the partial pressure of unloaded 0.5 m and 2 m TEDA, and unloaded 2.5 m PZ/2.5 m TEDA, compared to unloaded 0.5 m PZ.

FIG. 5 provides the amine partial pressure of loaded 2.5 m PZ/2.5 m TEDA, compared to unloaded 2.5 m PZ/2.5 m TEDA.

FIG. 6 demonstrates CO₂ solubility for 4 m PZ/4 m TEDA. 4 m PZ/4 m TEDA equation model (solid line); measured data for 4 m PZ/4 m TEDA using WWC (solid circles); and 8 m PZ equation model (dashed lines) is depicted.

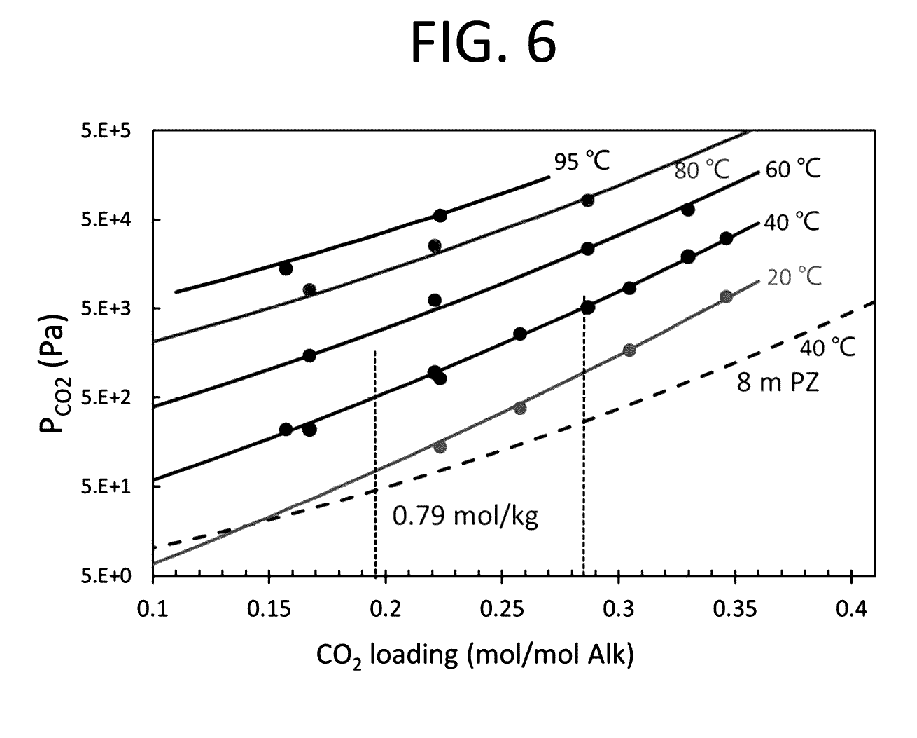

FIG. 7 provides mass transfer coefficients (kg′) in 4 m PZ/4 m TEDA (solid lines) from 40 to 95° C., compared to that in 8 m PZ (dashed line) at 40° C.

FIG. 8 provides the liquid-solid transition temperature for 4 m PZ/4 m Hydroxyethylmorpholine as compared to that previously reported for 8 m PZ.

FIG. 9 provides the CO₂ solubility for 4 m PZ/4 m Hydroxyethylmorpholine at various temperatures. 4 m PZ/4 m Hydroxyethylmorpholine equation model (solid line); measured data for 4 m PZ/4 m Hydroxyethylmorpholine using WWC (solid circles); and 8 m PZ equation model at 40° C. (dashed lines) is depicted.

FIG. 10 provides mass transfer coefficients (kg′) in 4 m PZ/4 m Hydroxyethylmorpholine, compared to that in 8 m PZ (dashed line) and 5 m PZ/5 m MDEA at 40° C.

FIG. 11 provides the MSA gradient ramp schedule used to determine the concentration of parent amine in degraded samples described in Example 3.

FIG. 12 provides the MSA gradient ramp schedule used to determine the concentration of parent amine in degraded samples in Example 4.

FIG. 13 provides a plot of the partial pressures of HMPD in loaded 2 m PZ/3 m HMPD at different temperatures, compared to AMP in 5 m PZ/2.3 m AMP, and to 8 m PZ and 7 m MEA.

FIG. 14 provides a plot of Partial pressure of HMPD in 2 m PZ/3 m HMPD and 3 m PZ/3 m HMPD with variable CO₂ loading at 40° C., compared to MDEA in 5 m PZ/5 m MDEA, AMP in 5 m PZ/2.3 m AMP, 8 m PZ and 7 m MEA.

FIG. 15 provides a plot of viscosity of 2 m PZ/3 m HMPD, 3 m PZ/3 m HMPD, and 4 m PZ/2 m HMPD with variable CO₂ partial pressure at 40° C., compared to 5 m PZ and 8 m PZ.

FIG. 16 provides a plot of CO₂ solubility at variable temperature for 2 m PZ/3 m HMPD, compared to 5 m PZ and 8 m PZ.

FIG. 17 provides a plot of mass transfer coefficients (kg′) in 2 m PZ/3 m HMPD, 3 m PZ/3 m HMPD, and 5 m PZ/5 m HMPD at 40° C., compared to 7 m MEA, 5 m PZ, and 8 m PZ.

FIG. 18 provides a plot of normalized CO₂ capacity and average mass transfer coefficients (kg′) at 40° C. for 2 m PZ/3 m HMPD, 3 m PZ/3 m HMPD, and 5 m PZ/5 m HMPD compared to 5 m PZ, 8 m PZ, 4 m PZ/4 m 2MPZ, 5 m PZ/5 m MDEA, and 7 m MEA.

FIG. 19 provides a plot of melting transition temperature for loaded 2 m PZ/3 m HMPD and 3 m PZ/3 m HMPD blends and 2 m PZ, 3 m PZ, 5 m PZ, and 8 m PZ over a range of CO₂ loading.

### DESCRIPTION

The present disclosure is directed to solvent compositions and methods for amine scrubbing of liquids using said solvent compositions. In one embodiment, an aqueous solvent is provided that comprises piperazine and triethylenediamine (TEDA) (referred to herein as PZ/TEDA). In one embodiment, the concentration of PZ is from about 2.00 molal to about 4 molal and the concentration of TEDA is from about 2.50 molal to about 7 molal. In these or other embodiments, the PZ and TEDA comprise from about 10 to about 60 wt % of the solvent and the PZ/TEDA comprise a concentration from about 4 to 12 equivalents/kg water of the solvent.

In one particular instance, the aqueous solvent comprises 4 molal PZ and 4 molal TEDA. In this instance, the solvent has a viscosity of about 9.90 cP to about 12.10 cP at a CO2 loading of about 0.15 mol/mol alkalinity to about 0.3 mol/mol alkalinity, respectively, at a temperature of 40° C. Solvents of 4 molal PZ and 4 molal TEDA may further comprise a working capacity of 0.79 mole per kg amines (PZ/TEDA)+water.

In another particular instance, the aqueous solvent comprises 2.5 molal PZ and 2.5 molal TEDA. In this instance, the solvent is free of solidification at 150° C. for at least 10 days when loaded with CO2 at 0.2 mol/mol alkalinity. Furthermore, at these concentrations of amines, the loss of piperazine and TEDA is 15% and 25%, respectively, at 150° C. for at least 10 days. Solvents of 2.5 molal PZ and 2.5 molal TEDA possess a first order rate constant for thermal degradation of piperazine at 150° C. that is less than or equal to 350 k₁×10⁻⁹ (s⁻¹), and in some instances, less than or equal to 150 k₁×10⁻⁹ (s⁻¹).

In another embodiment, an aqueous solvent is provided that comprises piperazine and imidazole or imidazole derivatives. The piperazine and imidazole or imidazole derivative may comprise about 10 to 60 wt % of the solvent and a concentration from about 4 to 12 equivalents/kg water of the solvent. The concentration of piperazine in the solvent is from about 2.00 molal to about 7 molal, and more preferably about 4.00 molal. The concentration of imidazole or its derivative is from about 2.00 molal to about 7 molal, and more preferably about 4.00 molal. In one instance, the imidazole derivative has a molecular weight of less than 150 g/mol. Examples of acceptable imidazole derivatives include 2-ethylimidazole, 1-methylimidazole, 2-methylimidazole, 4-methylimidazole, 1,2-dimethylimidazole, 1-(3-Aminopropyl)imidazole, and 2-ethyl-4-methylimidazole. In one specific embodiment, the aqueous solvent comprises piperazine and 1-methylimidazole. In another specific embodiment, the aqueous solvent comprises piperazine and 2-methylimidazole. In another specific embodiment, the aqueous solvent comprises piperazine and 4-methylimidazole. In another specific embodiment, the aqueous solvent comprises piperazine and 1,2-dimethylimidazole. In another specific embodiment, the aqueous solvent comprises piperazine and 1-(3-aminopropyl)imidazole. In another specific embodiment, the aqueous solvent comprises piperazine and 2-ethyl-4-methylimidazole. In any of the above specific embodiments, the concentration of piperazine is 4 molal and the concentration of the imidazole derivative is 4 molal. However, it should be understood that the concentrations may be varied to some degree based on the targeted end use for the aqueous solvent.

In another embodiment, an aqueous solvent is provided that comprises piperazine and a tertiary morpholine. In one particular instance, the tertiary morpholine comprises a hydroxyalkyl substituent group attached to a tertiary amino functional group. Furthermore, the hydroxyalkyl substituent group and tertiary amino functional group may be separated by about two or three carbon atoms. The piperazine and tertiary morpholine may comprise from about 10 to about 60 wt % of the solvent and comprise a concentration from about 4 to 12 equivalents/kg water of the solvent. Examples of suitable tertiary morpholine species include hydroxyethylmorpholine, hydroxypropylmorpholine, and hydroxyisopropylmorpholine.

In one particular embodiment, the aqueous solvent comprises piperazine and hydroxyethylmorpholine. In one instance, piperazine is at a concentration from about 2.00 molal to about 7.00 molal and more particularly, is about 5.00 molal, and the concentration of hydroxyethylmorpholine is from about 2.00 molal to about 7 molal and more particularly is about 5.00 molal. In this embodiment, piperazine possesses a degradation rate of 17×10⁻⁹ l/sec and hydroxyethylmorpholine possesses a degradation rate of 11×10⁻⁹ l/sec at temperatures of 150° C. Thus, aqueous solvents comprising piperazine and hydroxyethylmorpholine are significantly more stable than solvents comprising piperazine and one of MDEA, DEAE, or TEA, which result in piperazine degradation of 780×10⁻⁹ l/sec, 260×10⁻⁹ l/sec, and 280×10⁻⁹ l/sec, respectively, at a temperature of 150° C., and result in MDEA degradation of 330×10⁻⁹ l/sec, DEAE degradation of 170×10⁻⁹ l/sec, and TEA degradation of 160×10⁻⁹ l/sec.

In another particular embodiment, the aqueous solvent comprises piperazine and hydroxypropylmorpholine. In one instance, piperazine is at a concentration from about 2.00 molal to about 7.00 molal and more particularly, is about 5.00 molal, and the concentration of hydroxypropylmorpholine is from about 2.00 molal to about 7 molal and more particularly is about 5.00 molal. In this embodiment, piperazine possesses a degradation rate of 10×10⁻⁹ l/sec and hydroxypropylmorpholine possesses a degradation rate of 5.6×10⁻⁹ l/sec at temperatures of 150° C. Thus, aqueous solvents comprising piperazine and hydroxypropylmorpholine are significantly more stable than solvents comprising piperazine and one of MDEA, DEAE, or TEA, which result in piperazine degradation of 780×10⁻⁹ l/sec, 260×10⁻⁹ l/sec, and 280×10⁻⁹ l/sec, respectively, at a temperature of 150° C., and result in MDEA degradation of 330×10⁻⁹ l/sec, DEAE degradation of 170×10⁻⁹ l/sec, and TEA degradation of 160×10⁻⁹ l/sec.

In another particular embodiment, the aqueous solvent comprises piperazine and hydroxyisopropylmorpholine. In one instance, piperazine is at a concentration from about 2.00 molal to about 7.00 molal and more particularly, is about 5.00 molal, and the concentration of hydroxyisopropylmorpholine is from about 2.00 molal to about 7 molal and more particularly is about 5.00 molal. In this embodiment, piperazine possesses a degradation rate of 14×10⁻⁹ l/sec and hydroxyisopropylmorpholine possesses a degradation rate of 11×10⁻⁹ l/sec at temperatures of 150° C. Thus, aqueous solvents comprising piperazine and hydroxyisopropylmorpholine are significantly more stable than solvents comprising piperazine and one of MDEA, DEAE, or TEA, which result in piperazine degradation of 780×10⁻⁹ l/sec, 260×10⁻⁹ l/sec, and 280×10⁻⁹ l/sec, respectively, at a temperature of 150° C., and result in MDEA degradation of 330×10⁻⁹ l/sec, DEAE degradation of 170×10⁻⁹ l/sec, and TEA degradation of 160×10⁻⁹ l/sec.

In yet another embodiment, an aqueous solvent is provided that comprises piperazine and 4-hydroxy-1-methyl piperidine (HMPD). The piperazine and HMPD may comprise from about 10 to about 60 wt % of the solvent and comprise a concentration from about 4 to 12 equivalents/kg water of the solvent. The concentration of PZ in this embodiment is from about 0.50 molal to about 7.00 molal, and the concentration of HMPD is from about 1.00 molal to about 7.00 molal. In one particular embodiment, the aqueous solvent comprises 2 molal PZ and 3 molal HMPD. In another particular embodiment, the aqueous solvent comprises 3 molal PZ and 3 molal HMPD. In another particular embodiment, the aqueous solvent comprises 4 molal PZ and 2 molal HMPD. In yet another particular embodiment, the aqueous solvent comprises 5 molal PZ and 5 molal HMPD. In any of these particular embodiments, the aqueous solvent possesses a maximum stripper operating temperature of 150-155° C., wherein the maximum stripper operating temperature is defined as the temperature which corresponds to an overall amine degradation rate of 2.9×10⁻⁸ s⁻¹. Thus, aqueous solvents comprising PZ/HMPD blends are significantly more thermally stable than solvent blends comprising PZ/MDEA, PZ/AMP, or MEA.

In addition, the Examples herein demonstrate that aqueous solvents comprising PZ/HMPD provide the following advantageous properties as compared to other commonly used CO₂ capture solvents: (1) loaded PZ/HMPD solvents, particularly solvents comprising 2 m PZ/3 m HMPD or 3 m PZ/3 m HMPD, have similar amine partial pressure to 7 m MEA, but lower partial pressure than 5 m PZ/2.3 m AMP; (2) viscosity of PZ/HMPD solvents, particularly solvents comprising 2 m PZ/3 m HMPD, is about 10% higher than 5 m PZ and viscosity of 3 m PZ/3 m HMPD is about 50% higher than 5 m PZ, but is still only half of the viscosity of 8 m PZ; (3) normalized CO₂ capacity of PZ/HMPD solvents, particularly solvents comprising 2 m PZ/3 m HMPD or 3 m PZ/3 m HMPD, is comparable to 8 m PZ and 5 m PZ/5 m MDEA, but 20% higher than 5 m PZ, and 50% higher than 7 m MEA; (4) CO₂ absorption rate of PZ/HMPD solvents, particularly solvents comprising 2 m PZ/3 m HMPD or 3 m PZ/3 m HMPD, is 15% lower than 5 m PZ, but 20% higher than 8 m PZ and 5 m PZ/5 m MDEA, and 2.3 times higher than 7 m MEA; (5) assuming that normalized capacity has the same effect as absorption rate on the overall CO₂ capture cost, PZ/HMPD solvents, particularly solvents comprising 2 m PZ/3 m HMPD or 3 m PZ/3 m HMPD, will have similar CO₂ capture cost to 5 m PZ, but lower than 8 m PZ, 5 m PZ/5 m MDEA, or 5 m PZ/5 m HMPD; (6) solid solubility of PZ/HMPD solvents, particularly solvents comprising 2 m PZ/3 m HMPD or 3 m PZ/3 m HMPD, is significantly better than 5 m PZ and 8 m PZ; and (7) at the lean loading giving CO₂ partial pressure of 100 Pa at 40° C., the melting transition temperature is 23° C. for 8 m PZ, 18° C. for 5 m PZ, 8° C. for 3 m PZ/3 m HMPD, and 5° C. for 2 m PZ/3 m HMPD. Thus, aqueous solvents comprising PZ/HMPD, and particularly 2 m PZ/3 m HMPD solvents, provide a superior solvent for CO₂ capture from coal-fired flue gas, showing comparable CO₂ absorption performance to 5 m PZ, but much better solvent solubility.

A method for CO₂ capture from an acidic gas is also provided. In one embodiment, the method comprises contacting an acidic gas with an aqueous solvent comprising piperazine and a second compound. In some embodiments, the method further comprises an initial step of obtaining the acidic gas from a source such as a fossil fueled power plant, a natural gas reservoir, or an industrial process gas source. In yet other embodiments, the method further comprises the step of thermally regenerating the solvent in a single process column and/or process vessel or a series of process columns and/or process vessels at above atmospheric pressure and at a temperature is from about 120° C. to about 200° C. More specifically, the temperature is from about 145° C. to about 155° C. In another embodiment, the method further comprises the step of thermally regenerating the solvent in a simple stripper, single-stage flash, two stage flash, or advanced flash stripper.

In any of the above described method embodiments, piperazine and the second compound comprise about 10 to 60 wt % of the solvent and comprise a concentration from about 4 to 12 equivalents/kg water of the solvent.

In any of the above method embodiments, the concentration of piperazine is from about 0.50 molal to about 7.00 molal. In particular embodiments, the concentration of piperazine is 0.50 molal, 1.00 molal, 2.00 molal, 2.5 molal, 3.00 molal, 4.00 molal, 5.00 molal, 6.00 molal, or 7.00 molal.

In any of the above method embodiments, the concentration of the second compound is from about 1.00 molal to about 7.00 molal. In particular embodiments, the concentration of the second compound is 1.00 molal, 2.00 molal, 2.50 molal 3.00 molal, 4.00 molal, 5.00 molal, 6.00 molal, or 7.00 molal.

In any of the above method embodiments, the second compound is selected from the group consisting of imidazole, 2-ethylimidazole, 1-methylimidazole, 2-methylimidazole, 4-methylimidazole, 1,2-dimethylimidazole, 1-(3-Aminopropyl)imidazole, 2-ethyl-4-methylimidazole, a tertiary morpholine, hydroxyethylmorpholine, hydroxypropylmorpholine, hydroxyisopropylmorpholine, triethylenediamine, and 4-hydroxy-1-methyl piperidine.

To facilitate a better understanding of the present invention, the following examples of specific instances are given. In no way should the following examples be read to limit or define the entire scope of the invention.

### Example 1

### Properties of Piperazine (PZ)/Triethylenediamine (TEDA) for CO₂ Capture

### Materials and Methods

### Solution Preparation

Aqueous PZ/TEDA was prepared by melting anhydrous PZ (99%, Alfa Aesar, Ward Hill, Mass.) in water and TEDA (99%, Alfa Aesar, Ward Hill, Mass.) mixture, and gravimetrically sparging CO2 (99.5%, Matheson Tri Gas, Basking Ridge, N.J.) to achieve the desired CO2 concentration. The concentration of CO2 was determined by total inorganic carbon (TIC) analysis described by Hilliard M D., A Predictive Thermodynamic Model for an Aqueous Blend of Potassium Carbonate, Piperazine, and Monoethanolamine for Carbon Dioxide Capture from Flue Gas. The University of Texas at Austin, Austin, Tex., 2008 (dissertation).

### Solvent Solubility

The transition temperature of PZ/TEDA with variable amine concentration was measured in a water bath over a range of CO2 loading from 0 to 0.4 mol/mol alkalinity. The solid solubility measurements were based on visual observations and the method was described in detail by Freeman S A., Thermal Degradation and Oxidation of Aqueous Piperazine for Carbon Dioxide Capture. The University of Texas at Austin, Austin, Tex., 2011 (dissertation) (hereinafter “Freeman”). Solutions with desired properties were heated up to 50° C. in a water bath to melt precipitates in solution with lean CO2 loading. While cooling slowly, the temperature at which the solution first began to crystallize or precipitate was regarded as the crystallizing transition temperature. Finally, the solution was heated again to carefully observe the temperature when the crystals fully melt and this was noted as the melting transition temperature. The difference between crystallizing and melting transition temperature, which is also called hysteresis, was minimized to 1° C. or less for most of the measured points by giving enough equilibrium time and repeating the melting-crystallizing process at transition temperatures.

### Viscosity Measurements

Viscosity of 4 m PZ/4 m TEDA with 0.15-0.30 mol CO2/mol alkalinity was measured at 40° C. using a Physica MCR 300 cone and plate rheometer (Anton Paar GmbH, Graz, Austria). The method was also described by Freeman. The average value and standard deviation calculated from 10 individual measurements for each sample was reported.

### Thermal Degradation

Thermal degradation was measured in ⅜″ 316 stainless steel Swagelok® cylinders with a volume of 4.5 ml and diameter of 0.95 cm. Cylinders were filled with 4 mL of amine solution with around 0.5 mL of headspace, sealed with two Swagelok® end caps, and placed in forced convection ovens maintained at the target temperature. Individual cylinders were removed from the ovens at each sampling point and then analyzed for degradation products, degradation rate, and CO2 loading, using a Dionex ICS-2500 cation ion chromatograph, a Dionex ICS-3000 modular Dual Reagent-Free anion ion chromatograph (Dionex Corporation) and an infrared CO2 analyzer (Horiba Instruments Inc., Spring, Tex.). The details of the experimental apparatus, procedure, and analytical methods are described by Freeman, Ind Eng Chem Res 2012; 51(22):7726-35.

### Oxidation

Oxidative degradation experiments for 4 m PZ and 4 m TEDA, loaded with 0.2 mol CO2/mol alkalinity and spiked with 0.05 mM Cr3+, 01 mM Ni2+, 0.4 mM Fe2+ and 0.1 mM Mn2+, were conducted in a low gas flow agitated reactor with 100 mL/min of a saturated 98%/2% O2/CO2 gas mixture fed into the reactor headspace. The duration of the experiment is 2 weeks and 3 ml samples were taken every two to three days and water was added periodically to maintain the water balance of the reactor contents. The liquid samples were analyzed for PZ, TEDA, and degradation products using ion chromatography. The details of the experimental apparatus, procedure, and analytical methods are described by Sexton A J., Amine oxidation in CO2 capture processes. The University of Texas at Austin, Austin, Tex., 2008 (dissertation) (hereinafter “Sexton”).

### Volatility

Amine volatility was measured in a stirred reactor coupled with a hot gas FTIR analyzer (Fourier Transform Infrared Spectroscopy, Temet Gasmet Dx-4000). This was the same method and apparatus used by Nguyen T., Amine Volatility in CO2 Capture. The University of Texas at Austin, Austin, Tex., 2013 (dissertation) (hereinafter “Nguyen”) to measure amine volatility and CO2 partial pressure in loaded solutions.

### CO2 Absorption Rate and Solubility

CO2 absorption rate and equilibrium partial pressure in 4 m PZ/4 m TEDA were measured from 20 to 95° C. using a wetted wall column (WWC), which countercurrently contacted an aqueous 4 m PZ/4 m TEDA solution with a saturated N2/CO2 stream on the surface of a stainless steel rod with a known surface area to simulate the situation of CO2 absorption in a absorber. The detailed description of wetted wall column measurement has been given by Li, GHGT-11, Kyoto, Japan, Nov. 18-22, 2012. Energy Procedia, 2013.

### Results and Discussion

### Solvent Solubility of PZ/TEDA

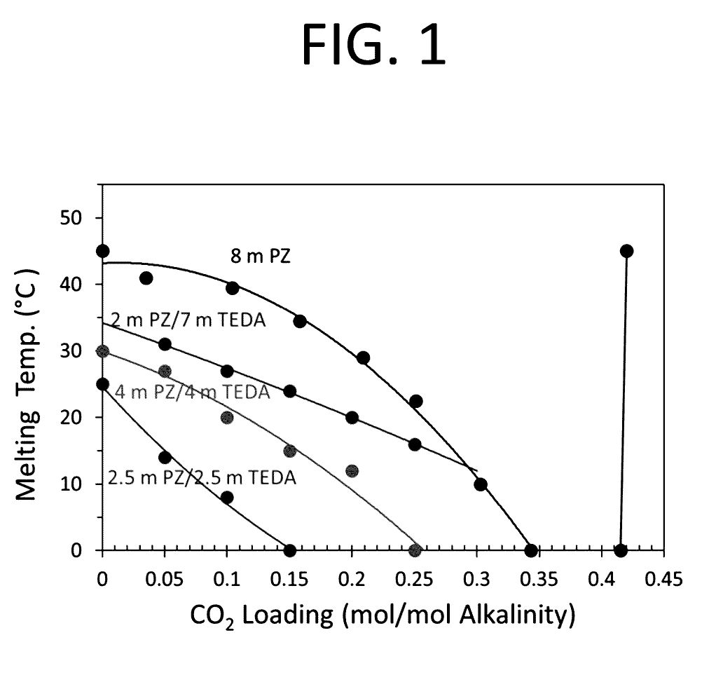

The melting transition temperature of PZ/TEDA with variable amine concentration over a range of CO2 loading from 0 to 0.4 mol/mol alkalinity is shown in FIG. 1. The transition temperature for non-blended 8 m PZ is also shown in FIG. 1 for comparison. As the proportion of PZ in the blend decreases, the transition temperature decreases. Unlike 8 m PZ, which also precipitates when CO2 loading reaches 0.44 mol CO2/mol alkalinity, as reported by Rochelle, Science 2009; 325(5948):1652-4, no precipitate was observed for the three blends at rich CO2 loading. Also, compared to 8 m PZ, the three blends require a lower CO2 loading to maintain a liquid solution without precipitation at room temperature (22° C.). CO2 loading has a smaller effect on the solubility of 2 m PZ/7 m TEDA. The precipitate in 2 m PZ/7 m TEDA at rich CO2 loading is believed to be TEDA, which cannot form carbamate with CO2.

### Viscosity

Viscosity of 4 m PZ/4 m TEDA with 0.15-0.30 mol CO₂/mol alkalinity was measured at 40° C. (Table 1). The results suggests that the viscosity of this blend is comparable to that of 8 m PZ [5] (i.e., 12.1 cP for 4 m PZ/4 m TEDA compared to 10.0 cP for 8 m PZ at 0.30 mol CO₂/mol alkalinity and 40° C.). The data also demonstrate that viscosity increases with increasing CO₂ concentration.

TABLE 1
Viscosity of 4 m PZ/4 m TEDA at 40° C.

| CO₂ Loading | Viscosity |
|---|---|
| (mol/mol alkalinity) | (cP) |
| 0.15 | 9.9 |
| 0.20 | 10.9 |
| 0.25 | 11.2 |
| 0.30 | 12.1 |

### Thermal Degradation

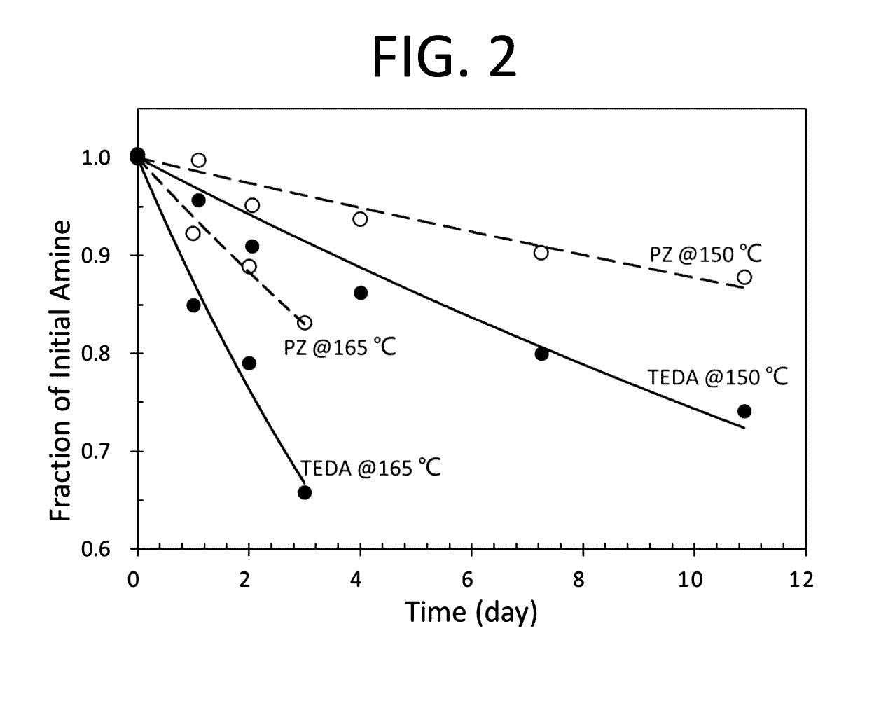

The thermal degradation of PZ/TEDA with variable amine concentration at CO₂ loading 0.2 mol/mol alkalinity was measured at 150° C., 165° C. and 175° C. At 175° C. and 165° C., solidification occurred for all loaded solvents (2 m TEDA, 0.6 m PZ/3 m TEDA, 2 m PZ/4 m TEDA, 2.5 m PZ/2.5 m TEDA, 4 m PZ/4 m TEDA) after 1-3 days. Unloaded 2 m TEDA was free of solidification and found to be stable at 165° C. The solidification was believed to be caused by the polymerization of TEDA itself or between PZ and TEDA. This could be due to the lack of protonated TEDA in the solution, which may be the initiating species required for the initial reactions of thermal degradation. At 150° C., solidification also occurred for loaded 2 m TEDA, 0.6 m PZ/3 m TEDA and 4 m PZ/4 m TEDA after 3-5 days. However, loaded 2.5 m PZ/2.5 m TEDA was free of solidification until 10 days at 150° C., though small precipitate was observed. In loaded 2.5 m PZ/2.5 m TEDA, the loss of PZ and TEDA at 150° C. was approximately 15% and 25%, respectively, after 10 days as shown in FIG. 2.

The thermal degradation of 2.5 m-PZ/2.5 m-TEDA is compared to that of 2 m-PZ/7m-MDEA and 8 m-PZ, and their apparent first order rate constants (k₁) for thermal degradation is given in Table 2. The TEDA in this blend degrades on the same scale as that of MDEA in 2 m PZ/7 m MDEA. However, the PZ in the blend degraded one order of magnitude slower than PZ in 2 m PZ/7 m MDEA, though it is still much faster than 8 m PZ. The relatively slow degradation of PZ in 2.5 m PZ/2.5 m TEDA is likely due to the lack of oxazolidone formation, which occurs in the degradation of 2 m PZ/7 m MDEA.

TABLE 2
Apparent first order rate constant (k₁) at 150° C.
for thermal degradation of PZ/TEDA and other related solvents.

| | | Loading | k₁ × 10⁻⁹ |
|---|---|---|---|
| Amine | Components | mol/mol alkalinity | (s⁻¹) |
| PZ | 2.5 m PZ/2.5 m TEDA | 0.20 | 150 |
| TEDA | 2.5 m PZ/2.5 m TEDA | 0.20 | 347 |
| PZ | 2 m PZ/7 m MDEA | 0.25 | 2050 |
| MDEA | 2 m PZ/7 m MDEA | 0.25 | 284 |
| PZ | 8 m PZ | 0.30 | 6.1 |

### Oxidative Degradation

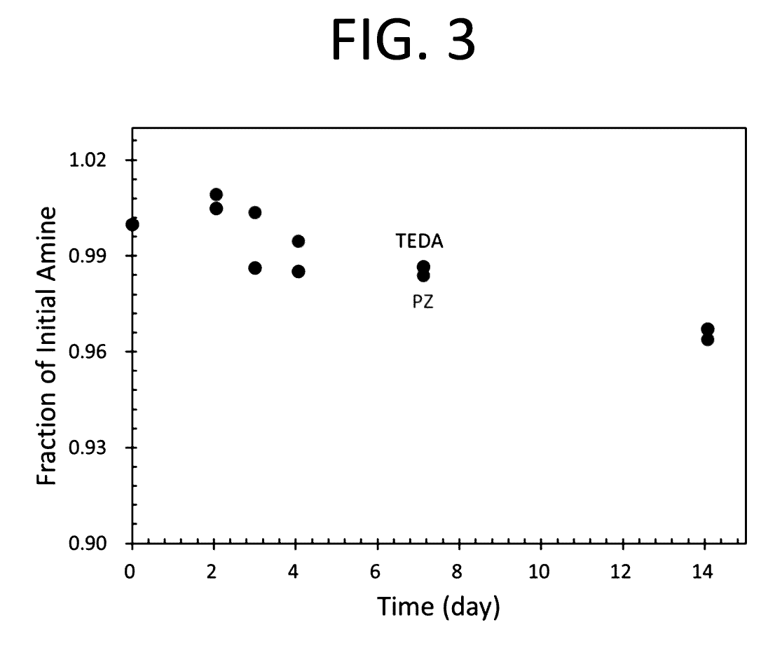

Oxidation of 4 m PZ/4 m TEDA at 70° C. in the presence of 0.1 mM Mn²⁺ and with the typical SSM mixture (0.4 mM Fe²⁺, 0.05 mM Cr³⁺ and 0.1 mM Ni²⁺), was investigated in low flow gas apparatus for 2 weeks. The amine loss is shown in FIG. 3, which demonstrates that both PZ and TEDA in 4 m PZ/4 m TEDA are resistant to oxidation.

### Volatility

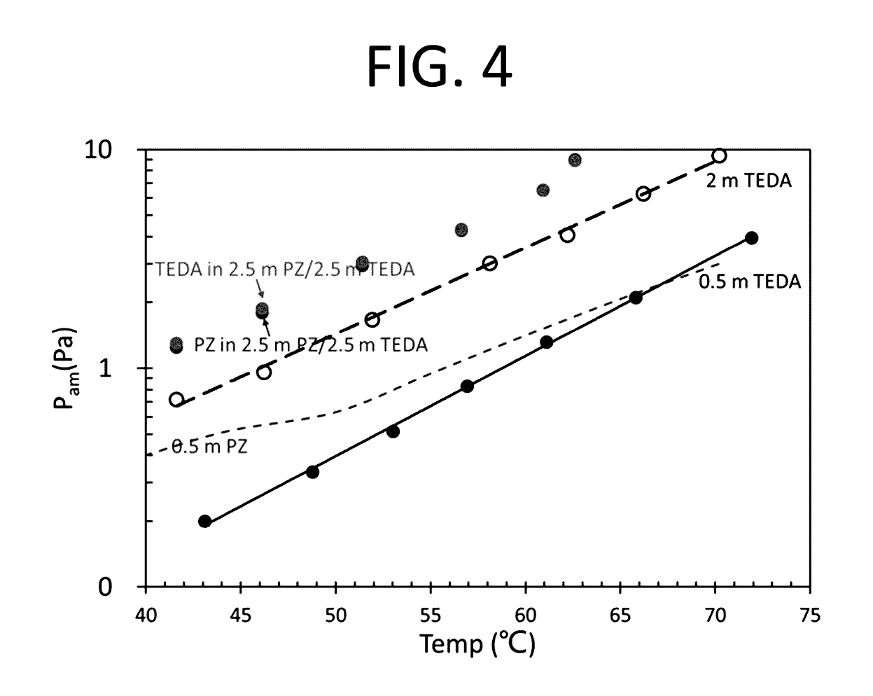

FIG. 4 shows the amine partial pressure of unloaded 0.5 m and 2 m TEDA, and unloaded 2.5 m PZ/2.5 m TEDA. The partial pressure of unloaded 0.5 m PZ was also shown for comparison as reported by Li, at GHGT-11, Kyoto, Japan, Nov. 18-22, 2012. Energy Procedia, 2013. The partial pressure of TEDA is comparable to PZ with same concentration. The data also demonstrates that partial pressure of TEDA increases with increasing concentration and temperature. In unloaded PZ/TEDA blend, PZ and TEDA show similar volatility.

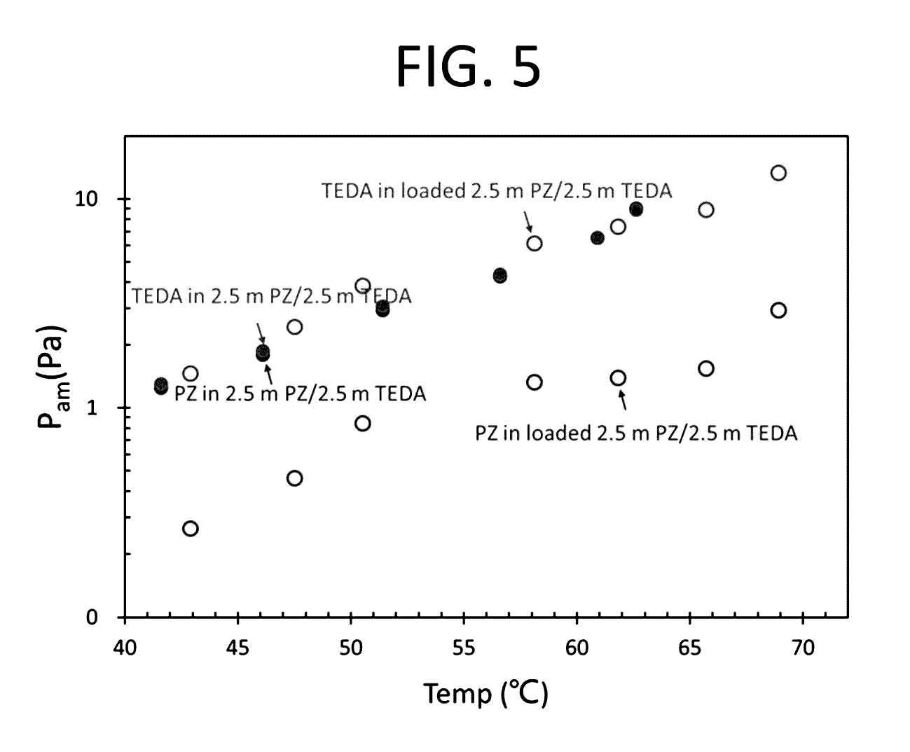

FIG. 5 shows the partial pressure of loaded 2.5 m PZ/2.5 m TEDA. The partial pressure of unloaded 2.5 m PZ/2.5 m TEDA was also shown for comparison. In the loaded solution, the partial pressure of PZ is almost one order manganite lower than TEDA. The loading of CO₂ have no significant effect on the volatility of TEDA. PZ can react with CO₂ to form carbamate which has much lower volatility than free PZ. But, TEDA, as a tertiary amine, cannot form carbamate.

### CO₂ Solubility

The CO₂ solubility in loaded 4 m PZ/4 m TEDA was measured from 20 to 95° C. CO₂ equilibrium partial pressure, P_{CO2} (Pa), was regressed using the following empirical model (Eq. 1) as a function of temperature, T (K), and CO₂ loading, a (mol CO₂/mol alkalinity), in the liquid phase.

$$ln {P}_{CO 2} = 37.41 - 11029 * \frac{1}{T} - 19.21 * a + 11315 * \frac{a}{T} + 16.68 * {a}^{2} + 667 * \frac{{a}^{2}}{T} \qquad Equation 1$$

CO₂ partial pressure of 4 m PZ/4 m TEDA is higher than that of 8 m PZ at 40° C., indicating a lower CO₂ solubility in this blend. Based on the difference in the equilibrium CO₂ partial pressure from 5 to 0.5 kPa at 40° C., the working capacity of 4 m PZ/4 m TEDA (0.79 mole per kg amines+water) is 10% lower than that of 8 m PZ [9] (0.86 mole per kg amines+water), but still much higher than that of 7 m MEA (0.50 mole per kg amines+water as reported by Li.).

### Absorption Rate

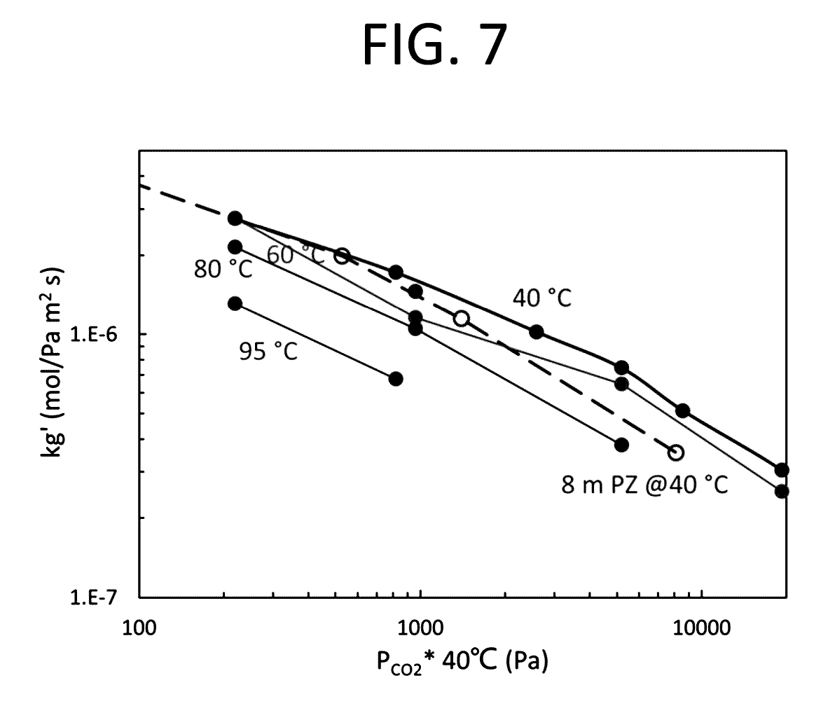

CO₂ absorption into 4 m PZ/4 m TEDA was also studied in the wetted wall column. The liquid-film mass coefficient (k_{g}′) of CO₂ absorption into 4 m PZ/4 m TEDA is shown in FIG. 7. To compare kg′ in 4 m PZ/4 m TEDA to that in 8 m PZ on the same basis, the rate data are plotted against partial pressure of CO₂ instead of CO₂ loading. To compare kg′ at variable temperature, the rate data of 4 m PZ/4 m TEDA at 40 to 95° C. is plotted as a function of the equilibrium partial pressure of CO₂ at 40° C. Compared to 8 m PZ, at 40° C. the blend has higher rate. Similar to other amines studied in CO₂ capture, temperature has a negative effect on CO₂ absorption rate into 4 m PZ/4 m TEDA.

### Conclusions

Blending PZ with TEDA can lower the solvent transition temperature. No precipitate was observed in PZ/TEDA at rich CO₂ loading. Additionally, the viscosity of 4 m PZ/4 m AEP is comparable to 8 m PZ.

4 m PZ/4 m TEDA is resistant to oxidative degradation, but it solidifies at high temperature (150° C.) after 4 days. 2.5 m PZ/2.5 m TEDA is free of solidification until 10 days at 150° C., though small precipitate was observed. The thermal degradation of 2.5 m PZ/2.5 m TEDA is slower than 2 m PZ/7 m MDEA, but faster than 8 m PZ.

The working capacity of 4 m PZ/4 m TEDA (0.79 mole per kg amines+water) is 10% lower than that of 8 m PZ (0.86 mole per kg amines+water), but still much higher than that of 7 m MEA (0.50 mole per kg amines+water). Kinetics measurements have shown that compared to 8 m PZ, at 40° C. 4 m PZ/4 m TEDA has great CO₂ absorption rate.

Compared to 8 m PZ, the greater solvent solubility and absorption rate, and comparable oxidation rate and viscosity, indicate that PZ/TEDA is an effective alternative solvent for CO₂ capture by absorption/stripping.

### Example 2

### Properties of Piperazine/Hydroxyethylmorpholine (HEM) as a CO₂ Capture Agent

### Methods

### Solution Preparation

A 4 molar (m) Piperazine (PZ)/4 m Hydroxyethylmorpholine solution was prepared gravimetrically and then sparged with CO₂ to the desired loadings of 0.05-0.35 mol CO₂/mol alkalinity. The loading of CO₂ was determined by total inorganic carbon (TIC) analysis, described by Freeman.

### Solvent Solubility

The solid solubility of 4 m PZ/4 m Hydroxyethylmorpholine was measured in a water bath over a range of CO₂ loading (from 0 to 0.35 mol CO₂/mol alkalinity), and temperature (from 0 to 50° C.). The solid solubility measurements were based on visual observations and the method was described in detail by Freeman. Solutions with desired properties were heated up to 50° C. in a water bath to melt precipitates in solution with lean CO₂ loading. While cooling slowly, the temperature at which the solution first began to crystallize or precipitate was regarded as the crystallizing transition temperature. Finally, the solution was heated again to carefully observe the temperature when the crystals fully melt and this was noted as the melting transition temperature. The difference between crystallizing and melting transition temperature, which is also called hysteresis, was minimized to 1° C. or less for most of the measured points by giving enough equilibrium time and repeating the melting-crystallizing process at transition temperatures.

### Viscosity Measurement

Viscosity of loaded amine solutions was measured using Physica MCR 300 cone and plate rheometer (Anton Paar, Graz, Austria). The temperature was precisely controlled within 0.01° C. by the apparatus. Viscosity was measured at 10 shear rates from 100 s⁻¹ and 1000 s⁻¹ and the average value was reported.

### CO₂ Absorption Rate and Solubility

CO₂ absorption rate and equilibrium partial pressure in 4 m PZ/4 m Hydroxyethylmorpholine were measured from 20 to 100° C. using a wetted wall column (WWC), which countercurrently contacted an aqueous 4 m PZ/4 m Hydroxyethylmorpholine solution with a saturated N₂/CO₂ stream on the surface of a stainless steel rod with a known surface area to simulate the situation of CO₂ absorption in a absorber. The detailed description of wetted wall column measurement has been given by Li et al., Energy Procedia. 37(0): 370-385 (2013).

### Results and Analysis

### Solid Solubility of PZ/HEM

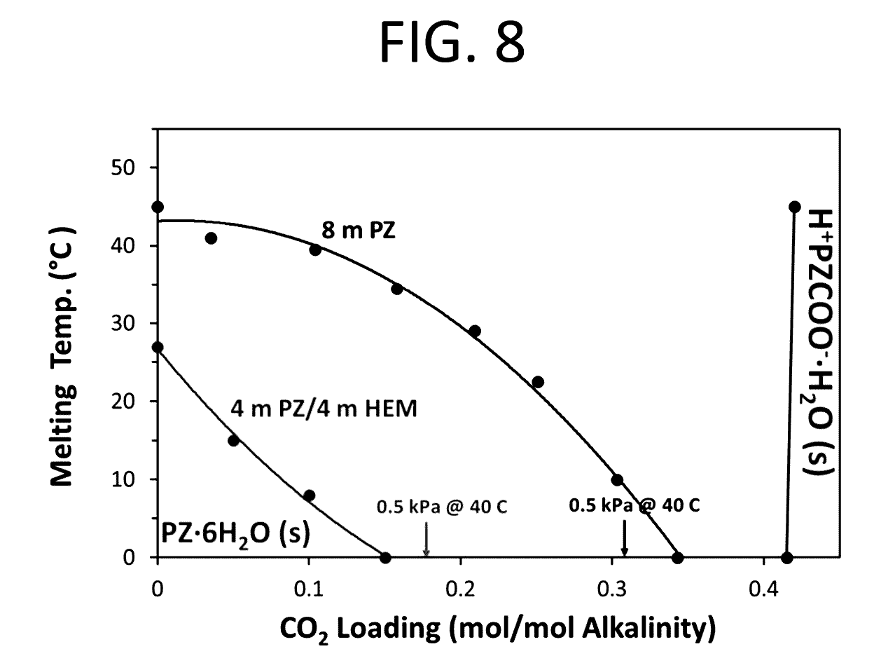

The melting transition temperature of 4 m PZ/4 m Hydroxyethylmorpholine over a range of CO₂ loading from 0 to 0.35 mol/mol alkalinity is shown in FIG. 8. The transition temperature for non-blended 8 m PZ from previous studies is also shown in FIG. 8 for comparison. For 4 m PZ/4 m Hydroxyethylmorpholine, a CO₂ loading of approximately 0.03 mol/mol alkalinity is required to maintain a liquid solution without precipitation at room temperature (20° C.), which is much lower than 0.26 mol/mol alkalinity required for 8 m PZ. Unlike 8 m PZ, which also precipitates when CO₂ loading reaches 0.44 mol CO₂/mol alkalinity, no precipitate was observed for the three blends at rich CO₂ loading (until CO₂ reached its solubility limit under atmospheric pressure, which is about 0.39 mol CO₂/mol alkalinity). Therefore, 4 m PZ/4 m Hydroxyethylmorpholine has a lower solvent solubility limit at lean loading, and is free from precipitation at rich loading under atmospheric pressure.

### Viscosity

Viscosity of 4 m PZ/4 m Hydroxyethylmorpholine with CO₂ loading from 0.1 to 0.30 mol CO₂/mol alkalinity was measured at 40° C. (Table 3). The results suggests that the viscosity of this blend is lower that of 8 m PZ (i.e., 7.0 cP for 4 m PZ/4 m Hydroxyethylmorpholine compared to 10.0 cP for 8 m PZ at 0.30 mol CO₂/mol alkalinity and 40° C.). The data also demonstrate the expected trend that viscosity increases with increasing CO₂ concentration.

TABLE 3
Viscosity of 4 m PZ/4 m Hydroxyethylmorpholine at 40° C.

| | CO₂ Loading | | | | |
|---|---|---|---|---|---|
| | (mol/mol alkalinity) | | | | |
| | 0.10 | 0.15 | 0.20 | 0.25 | 0.30 |
| Viscosity (cP) | 6.03 | 6.10 | 6.82 | 6.94 | 6.97 |

### CO₂ Solubility

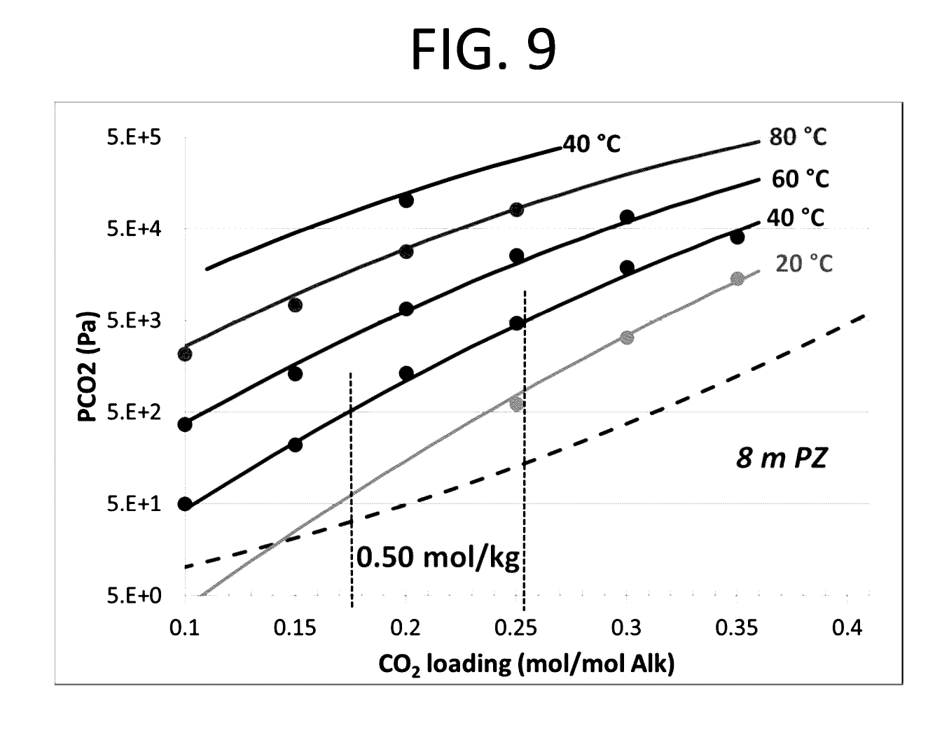

The CO₂ solubility in loaded 4 m PZ/4 m Hydroxyethylmorpholine was measured from 20 to 95° C. as shown in FIG. 9. CO₂ equilibrium partial pressure, P_{CO2} (Pa), was regressed using the following empirical model (Equation 2) as a function of temperature, T (K), and CO₂ loading, a (mol CO₂/mol alkalinity), in the liquid phase.

$$ln {P}_{CO 2} = 45.52 - 13319 * \frac{1}{T} - 22.59 * a + 19809 * \frac{a}{T} - 42.60 * {a}^{2} + 4518 * \frac{{a}^{2}}{T} \qquad Equation 2$$

The CO2 partial pressure of 8 m PZ is also given in FIG. 9 for comparison. Referring now to FIG. 9, it is shown that CO2 partial pressure of 4 m PZ/4 m Hydroxyethylmorpholine at 40° C. is consistently higher than that of 8 m PZ at the same temperature, indicating a lower CO2 solubility in this blend. Based on the difference in the equilibrium CO2 partial pressure from 5 to 0.5 kPa at 40° C., the working capacity of 4 m PZ/4 m Hydroxyethylmorpholine (0.50 mole per kg amines+water) is lower than that of 8 m PZ (0.86 mole per kg amines+water as reported by Li, et al, Energy Procedia. 37(0): 370-385), but still comparable to that of 7 m MEA (0.50 mole per kg amines+water).

### Absorption Rate

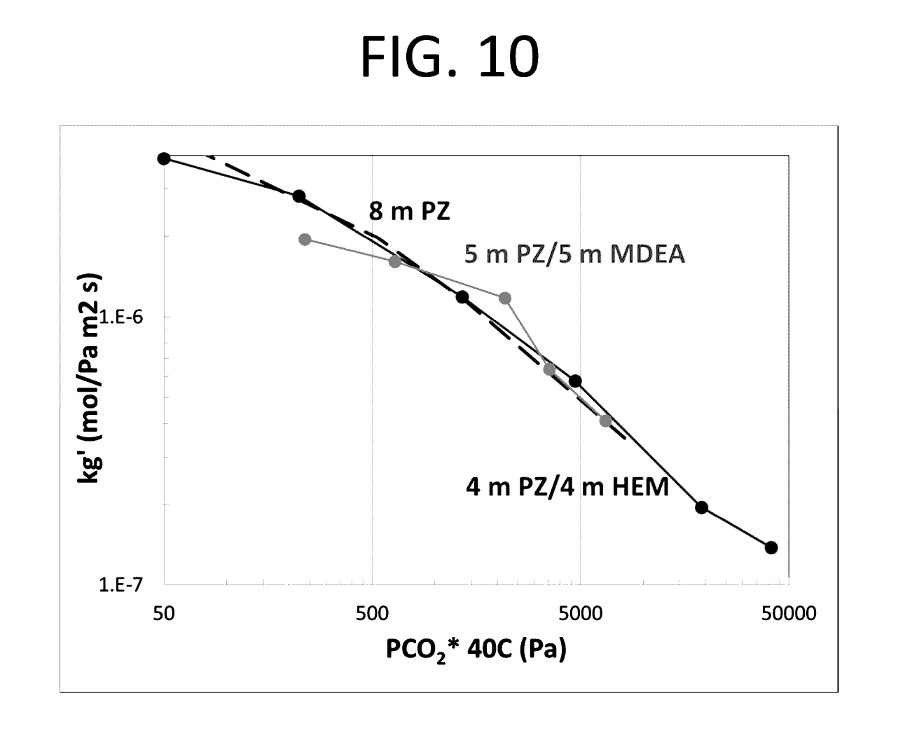

CO2 absorption rate into 4 m PZ/4 m Hydroxyethylmorpholine was also measured in the wetted wall column. The liquid-film mass coefficients (kg′) of CO2 absorption into 4 m PZ/4 m Hydroxyethylmorpholine at 40° C. are shown in FIG. 10. To compare kg′ in 4 m PZ/4 m Hydroxyethylmorpholine to that in 8 m PZ on the same basis, the rate data are plotted against partial pressure of CO2 instead of CO2 loading. Compared to 8 m PZ, at 40° C. the blend has similar rate.

### Example 3

### Properties of PZ/Imidazole and its Derivatives as a CO₂ Capture Agent

### Methods

Amine solutions were prepared gravimetrically. A 4 m PZ/4 m Imidazole (or imidazole derivatives) solution was prepared gravimetrically and then sparged with CO2 to a loading of 0.2 mol CO2/mol alkalinity. The imidazole and its derivatives that were tested are listed in Table 4.

TABLE 4
List of Imidazole and its derivatives tested

| Amine Name (Abbreviation)/ | | Molecular |
|---|---|---|
| CAS # | Structure | Weight |
| Imidazole (IMI)/288-32-4 | 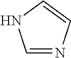 | 68.08 |
| 1-Methylimidazole (1M-IMI)/ 616-47-7 | 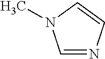 | 82.10 |
| 2-Methylimidazole (2M-IMI)/ 693-98-1 | 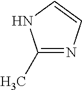 | 82.10 |
| 4(5)-Methylimidazole (4M- IMI)/822-36-6 | 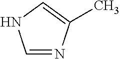 | 82.10 |
| 1,2-Dimethylimidazole (DIMI)/ 1739-84-0 | 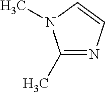 | 96.13 |
| 2-Ethylimidazole (2E-IMI)/ 1072-62-4 | 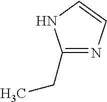 | 96.13 |
| 1-(3-Aminopropyl)imidazole (A-IMI)/5036-48-6 | 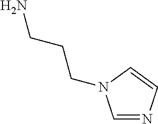 | 125.17 |
| 2-ethyl, 4 methyl imidazole | 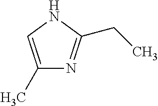 | 110 |

4 ml of the loaded 4 molal PZ/4 molal imidazole (or imidazole derivatives) solution was then placed inside 316 stainless steel Swagelok® cylinders with a volume of 4 ml and diameter of 0.95 cm. The cylinders, loaded with amine, were weighed, sealed, and placed inside convection ovens maintained at 165° C. Cylinders were removed at set intervals and were weighed after removal to ensure no mass was lost; cylinders that lost more than 5% of mass were discarded. The cylinders were then placed in refrigerated storage for sample preservation.

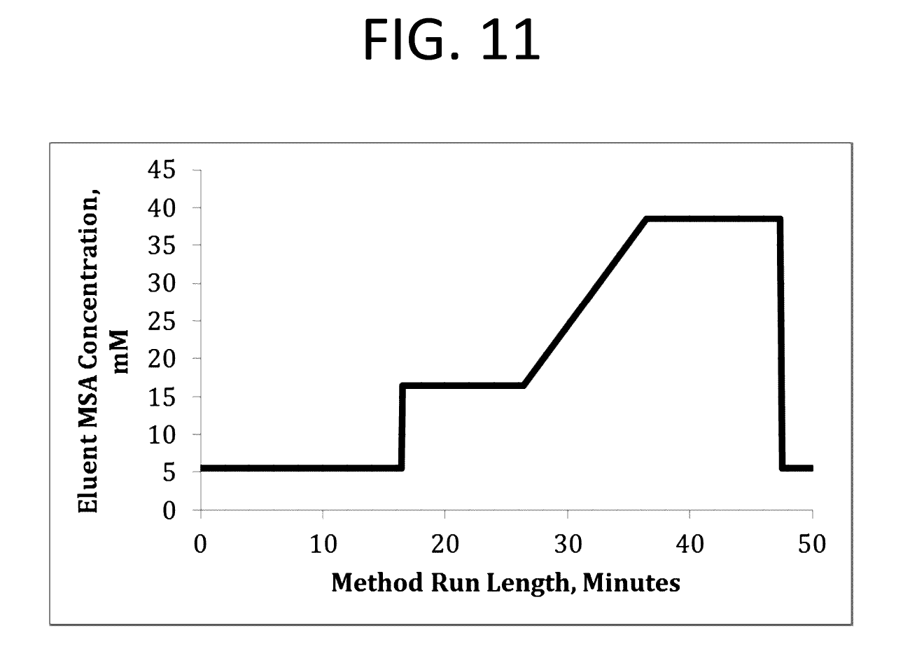

The degraded solutions were diluted by a factor of 10000 and were analyzed for parent amine concentration using suppressed cation chromatography. A Dionex ICS-2100 ion chromatograph with a CS17 4×250 mm analytical column and a CG17 4×50 mm guard column was used to carry out the separation. A gradient of methylsulfonic acid (MSA) in 18.2 μmho deionized water was used as the mobile phase with an eluent flow of 0.5 ml/min; the suppression current was set to a constant 50 mA. The gradient ramp schedule is shown in FIG. 11.

The degradation kinetics was assumed to be pseudo first-order with respect to the parent amine and are presented in Equation 3 and Equation 4.

$$\begin{matrix}\frac{d {C}_{Imidazole}}{d t} = - {k}_{Imidazole} * {C}_{Imidazole} & ( Equation 3 ) \\ \frac{d {C}_{PZ}}{d t} = - {k}_{PZ} * {C}_{PZ} & ( Equation 4 )\end{matrix}$$

These equations can be integrated to find the pseudo first-order degradation rate constants for PZ and Imidazole (or imidazole derivatives).

### Results and Analysis

Table 5 shows the pseudo first order degradation constant for the PZ-activated imidazole (or imidazole derivatives) at an initial concentration of 4 m PZ/4 m tertiary amine at an initial loading of about 0.2 mol CO₂/mol alkalinity at 165° C. For reference, the pseudo first order degradation rate of 8 m PZ and 2 m PZ/7 m methyldiethanolamine (MDEA) at 165° C. are also shown in Table 5.

TABLE 5
Degradation Rates of PZ-Activated Imidazole Solvents at 165° C.

| | Loading | k, PZ, | k, IMI, |
|---|---|---|---|
| Amine | (mol CO₂/mol alkalinity) | *10⁻⁹ 1/s | *10⁻⁹ 1/s |
| 4 m PZ/4 m IMI | 0.20 | 845 | a |
| 4 m PZ/4 m 1M-IMI | 0.20 | 208 | 185 |
| 4 m PZ/4 m 2M-IMI | 0.20 | 462 | 359 |
| 4 m PZ/4 m 4M-IMI | 0.20 | 301 | 532 |
| 4 m PZ/4 m DIMI | 0.20 | 150 | 127 |
| 4 m PZ/4 m 2E-IMI | 0.20 | b | 85 |
| 4 m PZ/4 m A-IMI | 0.20 | 243 | 706 |
| 8 m PZ | 0.30 | 31¹ | — |
| 2 m PZ/7 m MDEA | 0.25 | 7410² | 1255² (for MDEA) |

a: totally degraded;
b: lower than detection limit.

The results show that the 4 m PZ/4 m 2E-IMI solvents have a similar rate of thermal degradation as 8 m PZ, and all the other PZ-activated imidazole solvents (except for 4 m PZ/4 m IMI) are at least one to two orders of magnitude more stable than PZ-activated MDEA. Based on the results, 2-ethyl-4-methylimidazole is believed to be another competitive alternative.

### Example 4

### Properties of Piperazine and Tertiary Morpholines as a CO₂ Capture Agent

### Methods

Amine solutions were prepared gravimetrically. A 5 molar Piperazine (PZ) solution was prepared gravimetrically and then sparged with CO₂ to a loading of 0.34 mol CO₂/mol alkalinity. The morpholine-based tertiary amines were added to the 5 molal PZ solution to create blends of 5 molal PZ/5 molal tertiary amine with a loading of 0.23 mol CO₂/mol alkalinity. This CO₂ loading corresponds to the lean loading of 5 molal PZ/5 molal MDEA solutions in CO₂ capture applications from coal-derived flue gas. The tertiary morpholine derivatives that were tested are listed in Table 6:

TABLE 6
List of tertiary morpholines tested

| Tertiary Amine Name | | Molecular |
|---|---|---|
| Abbreviation/CAS # | Structure | Weight |
| Hydroxyethylmorpholine HEM/622-40-2 | 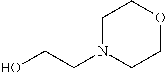 | 131.2 |
| Hydroxyisopropyl- morpholine HIPM/2109-66-2 | 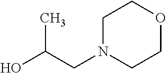 | 145.2 |
| Hydroxypropyl- morpholine HPM/4441-30-9 | 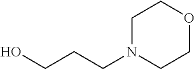 | 145.2 |

4 ml of the loaded 5 molal PZ/5 molal tertiary amine solution was then placed inside 316 stainless steel Swagelok® cylinders with a volume of 4.5 ml and diameter of 0.95 cm. The cylinders, loaded with amine, were weighed, sealed, and placed inside convection ovens maintained at 150° C. Cylinders were removed at set intervals and were weighed after removal to ensure no mass was lost; cylinders that lost more than 5% of mass were discarded. The cylinders were then placed in refrigerated storage for sample preservation.

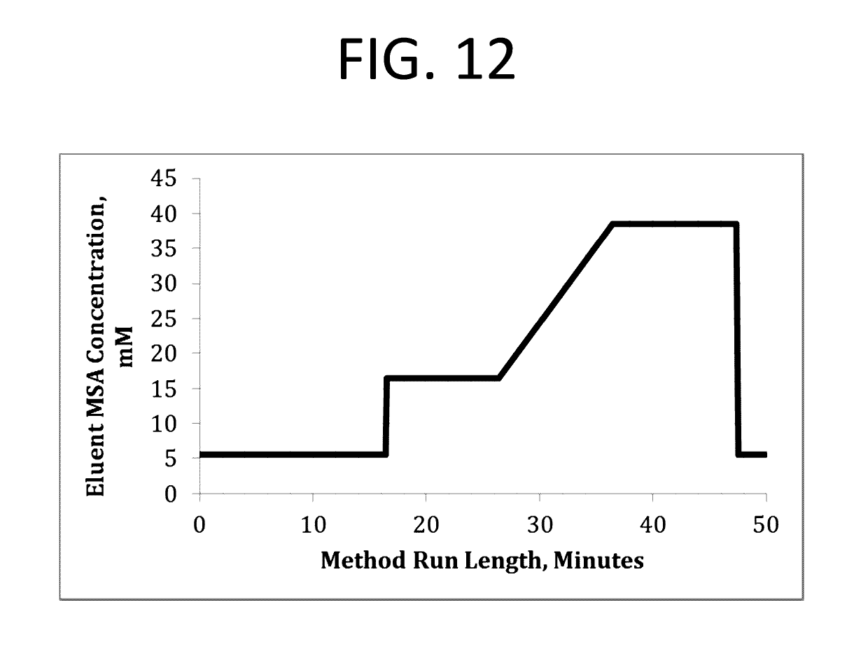

The degraded solutions were diluted by a factor of 10000 and were analyzed for parent amine concentration using suppressed cation chromatography. A Dionex ICS-2100 ion chromatograph with a CS17 4×250 mm analytical column and a CG17 4×50 mm guard column was used to carry out the separation. A gradient of methylsulfonic acid (MSA) in 18.2 μmho deionized water was used as the mobile phase with an eluent flow of 0.5 ml/min; the suppression current was set to a constant 50 mA. The gradient ramp schedule is shown in FIG. 12.

The degradation kinetics was assumed to be pseudo first-order with respect to the parent amine and are presented in Equation 5 and Equation 6.

$$\begin{matrix}\frac{d {C}_{Tertiary Amine}}{d t} = - {k}_{Tertiary Amine} * {C}_{Tertiary Amine} & ( Eq . 5 ) \\ \frac{d {C}_{PZ}}{d t} = - {k}_{PZ} * {C}_{PZ} & ( Eq . 6 )\end{matrix}$$

These equations can be integrated to find the pseudo first-order degradation rate constants for PZ and the tertiary amine.

### Results and Analysis

Table 7 shows the pseudo first order degradation constant for the PZ-activated tertiary morpholines in addition to PZ-activated methyldiethanolamine (MDEA), diethylaminoethanol (DEAE), and triethanolamine (TEA) at an initial concentration of 5 m PZ/5 m tertiary amine at an initial loading of about 0.23 mol CO₂/mol alkalinity at 150° C. For reference, the pseudo first order degradation rate of 8 m PZ at 150° C. and an initial loading of 0.3 mol CO₂/mol alkalinity is 6.1*10⁻⁹ l/sec.

TABLE 7
Degradation Rates of PZ-Activated
Tertiary Amine Solvents at 150° C.

| Tertiary Amine | k, PZ, 1/s | k, Tertiary Amine, 1/s |
|---|---|---|
| HEM | 17*10⁻⁹ | 11*10⁻⁹ |
| HIPM | 14*10⁻⁹ | 11*10⁻⁹ |
| HPM | 10*10⁻⁹ | 5.6*10⁻⁹ |
| MDEA | 780*10⁻⁹ | 330*10⁻⁹ |
| DEAE | 260*10⁻⁹ | 170*10⁻⁹ |
| TEA | 280*10⁻⁹ | 160*10⁻⁹ |

The results show that the PZ-activated tertiary morpholine solvents have a similar rate of thermal degradation as concentrated PZ and are at least one to two orders of magnitude more stable than PZ-activated MDEA, DEAE, and TEA.

The degradation mechanism of PZ-activated tertiary morpholines is thought to be initiated by a free PZ molecule attacking a carbon alpha to a protonated amino group on the tertiary morpholine ring, opening the ring and creating a triamine byproduct. This is shown in Reaction 1 below.

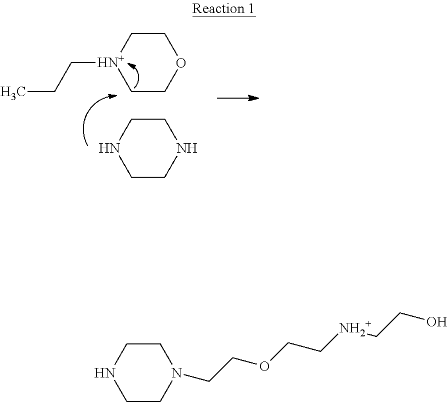

The triamine byproduct can undergo several different reactions. It can ring close to regenerate a piperazine molecule and a tertiary morpholine, shown in Reaction 2. This reaction is essentially the reverse of the reaction shown in Reaction 1. The triamine can also form an oxazolidinone and react with free PZ via the carbamate polymerization pathway. These reactions are shown in Reaction 3, and the overall degradation rate of PZ and tertiary morpholine suggest that the rate of reaction in Reaction 2 is much faster than the rate of reaction in Reaction 3. In particular, the reaction between the PZ and the oxazolidinone is a reason why the rate of PZ degradation is greater than the rate of tertiary amine degradation in the presence of CO₂.

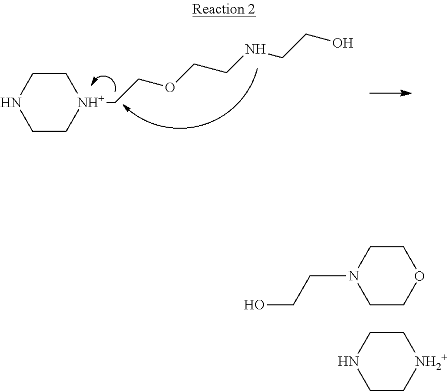 [SMILES: OCCNCCOCC[NH+]1CCNCC1 ; OCCN1CCOCC1 ; C1C[NH2+]CCN1]

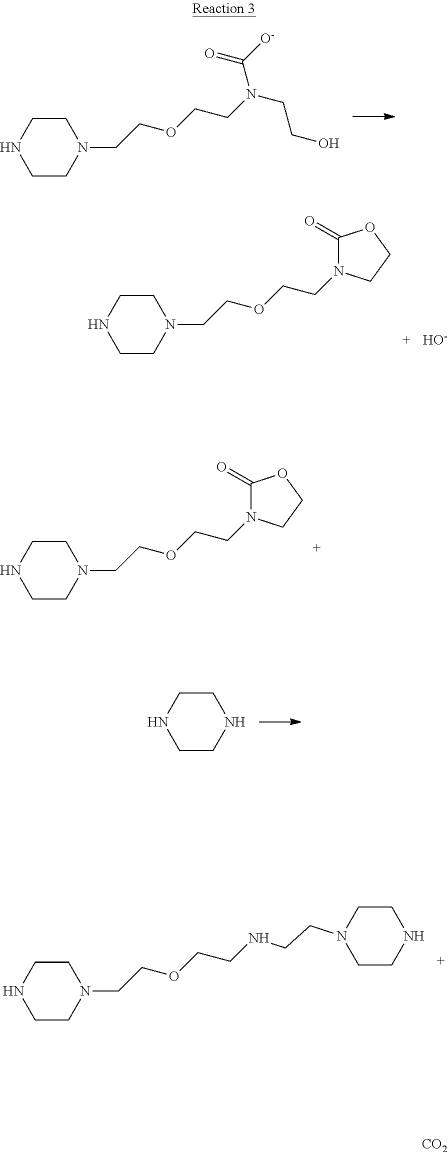

The net rate of Reaction 1 is much slower than SN2 attack of alkyl substituent groups attached to protonated tertiary amines, which is the primary degradation pathway seen in activated MDEA and DEAE solvents. Although not intended to be limited by theory, this could be due to either the stability of the carbons alpha to the amino function within the ring or due to the instability of the triamine to regenerate both parent amines.

Morpholine was present in degraded solutions of PZ-activated tertiary morpholines. However, the quantity of morpholine in degraded samples is too small to be quantified, and suggests that alpha carbon attack on the substituent group likely is not significant.

### Example 5

### Properties of Piperazine and 4-hydroxy-1-methyl piperidine (HMPD) as a CO₂ capture agent

### Materials and Methods

### Solution Preparation

Aqueous PZ/HMPD was prepared by melting anhydrous PZ in a mixture of water and the second amine, and gravimetrically sparging CO₂ (99.5%, Matheson Tri Gas, Basking Ridge, N.J.) to achieve the desired CO₂ concentration. The concentration of CO₂ was determined by total inorganic carbon (TIC) analysis, described by Freeman (2011).

### Thermal Degradation

Thermal degradation was measured in ⅜″ 316 stainless steel Swagelok® cylinders with a volume of 4.5 ml and diameter of 0.95 cm. Cylinders were filled with 4 mL of amine solution with around 0.5 mL of headspace, sealed with two Swagelok® end caps, and placed in forced convection ovens maintained at the target temperature. Individual cylinders were removed from the ovens at each sampling point and then analyzed for degradation products, degradation rate, and CO₂ loading, using a Dionex ICS-2500 cation ion chromatograph, a Dionex ICS-3000 modular Dual Reagent-Free anion ion chromatograph (Dionex Corporation) and an infrared CO₂ analyzer (Horiba Instruments Inc., Spring, Tex.). The details of the experimental apparatus, procedure, and analytical methods are described by Freeman (2011).

### Volatility

Amine volatility was measured in a stirred reactor coupled with a hot gas FTIR analyzer (Fourier Transform Infrared Spectroscopy, Temet Gasmet Dx-4000). This was the same method and apparatus used by Nguyen (2013) to measure amine volatility and CO₂ partial pressure in loaded solutions.

### Viscosity Measurements

Viscosity of loaded PZ/HMPD was measured at 40° C. using a Physica MCR 300 cone and plate rheometer (Anton Paar GmbH, Graz, Austria). The method was also described by Freeman (2011). The average value and standard deviation calculated from 10 individual measurements for each sample was reported.

### CO₂ Absorption Rate and Solubility

CO₂ absorption rate and equilibrium partial pressure in PZ/HMPD were measured from 20 to 100° C. using a wetted wall column (WWC), which countercurrently contacted an aqueous PZ/HMPD solution with a saturated N₂/CO₂ stream on the surface of a stainless steel rod with a known surface area to simulate the situation of CO2 absorption in a absorber. The detailed description of wetted wall column measurement has been given by Chen (2011).

### Solvent Solubility

The transition temperature of PZ/HMPD with variable amine concentration was measured in a water bath over a range of CO₂ loading from 0 to 0.6 mol/mol PZ. The solid solubility measurements were based on visual observations and the method was described in detail by Freeman (2011). Solutions with desired properties were heated up to 50° C. in a water bath to melt precipitates in solution with lean CO₂ loading. While cooling slowly, the temperature at which the solution first began to crystallize or precipitate was regarded as the crystallizing transition temperature. Finally, the solution was heated again to carefully observe the temperature when the crystals fully melt and this was noted as the melting transition temperature. The difference between crystallizing and melting transition temperature, which is also called hysteresis, was minimized to 2° C. or less for most of the measured points by giving enough equilibrium time and repeating the melting-crystallizing process at transition temperatures.

### Results and Discussion

### Thermal Stability

The thermal degradation of PZ/HMPD with various concentration ratios and CO₂ loadings was measured at 175° C. for 5 weeks. The maximum stripper operating temperature (Tₘₐₓ) for each solvent is defined as the temperature which corresponds to an overall amine degradation rate of 2.9×10⁻⁸ s⁻¹. Tₘₐₓ is used as an indicator for amine thermal stability. Tₘₐₓ for PZ/HMPD with various concentration ratios and CO₂ loadings is summarized in Table 8 and compared to other conventional solvents, such as PZ/MDEA, PZ/AMP and MEA. The thermal stability (as indicated by Tₘₐₓ) of PZ/HMPD blends is 150-155° C., which is much greater than PZ/MDEA, PZ/AMP, or MEA

TABLE 8
Tₘₐₓ for PZ/HMPD and other common solvents

| | CO₂ | Overall Tₘₐₓ |
|---|---|---|
| Amines | loading | (° C.) |
| 5 m PZ/5 m HMPD | 0.40 | 151 |
| 5 m PZ/5 m HMPD | 0.20 | 155 |
| 4 m PZ/2 m HMPD | 0.40 | 150 |
| 2 m PZ/7 m MDEA | 0.11 | 120 |
| 5 m PZ/2.3 m AMP | 0.40 | 134 |
| 8 m PZ | 0.30 | 163 |
| 7 m MEA | 0.40 | 122 |

### Amine Volatility

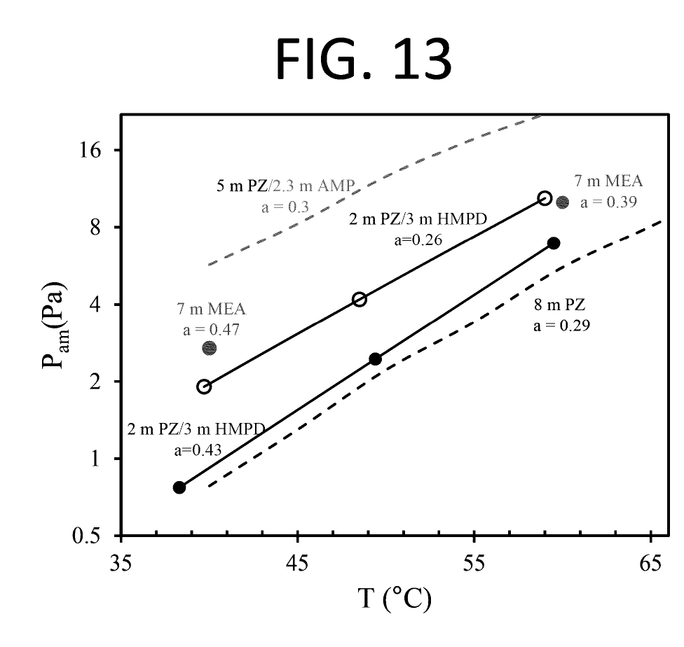

FIG. 13 shows the amine partial pressure of HMPD in loaded 2 m PZ/3 m HMPD at normal operating temperature, compared to AMP in 5 m PZ/2.3 m AMP, 8 m PZ and 7 m MEA (Nguyen, 2013). At normal lean loading condition, HMPD in loaded 2 m PZ/3 m HMPD has partial pressure that is twice as high as 8 m PZ, similar to 7 m MEA, but only ⅓ of AMP in 5 m PZ/2.3 m AMP. The data also demonstrate the expected trend that amine partial pressure increases with increasing temperature.

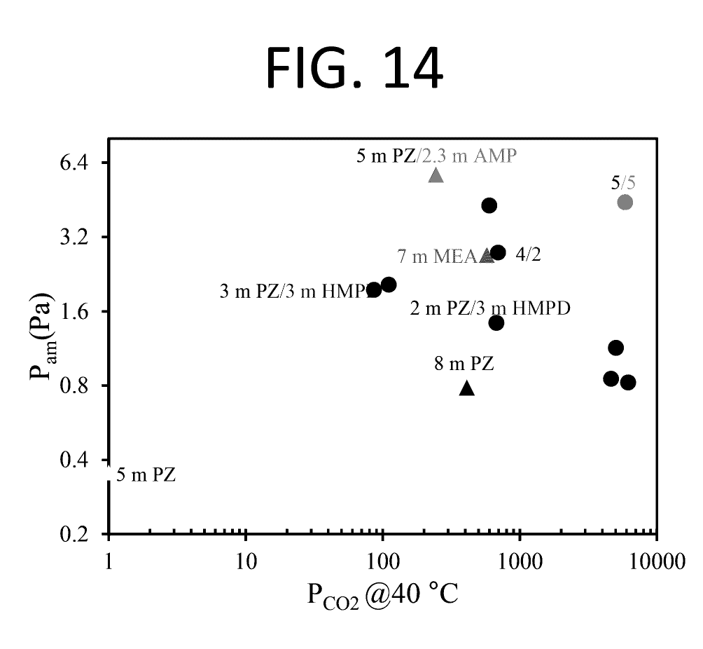

FIG. 14 shows the amine partial pressure of HMPD in PZ/HMPD at different CO₂ loadings at 40° C., compared to MDEA in 5 m PZ/5 m MDEA, AMP in 5 m PZ/2.3 m AMP, 8 m PZ and 7 m MEA. At the normal operating CO₂ loading range (100-10000 Pa), partial pressure of HMPD in 5 m PZ/5 m HMPD is similar to AMP in 5 m PZ/2.3 m AMP. The partial pressure of HMPD in 4 m PZ/2 m 4X, 2 m PZ/3 m 4X, and 3 m PZ/3 m 4X is comparable to 7 m MEA. The data also demonstrate the expected trend that amine partial pressure decreases with increasing CO₂ loading, except for HMPD in 3 m PZ/3 m HMPD. With increasing CO₂ loading, amine is gradually protonated or converted to amine carbamate. The partial pressure of HMPD in 3 m PZ/3 m HMPD at P_{CO2}=500 Pa is higher than that at P_{CO2}=100. This phenomenon was also observed in 5 m PZ/5 m MDEA. The increased partial pressure with increasing CO₂ loading may be caused by the salting out of the amine by the ionic strength that comes with greater CO₂ loading.

### Viscosity

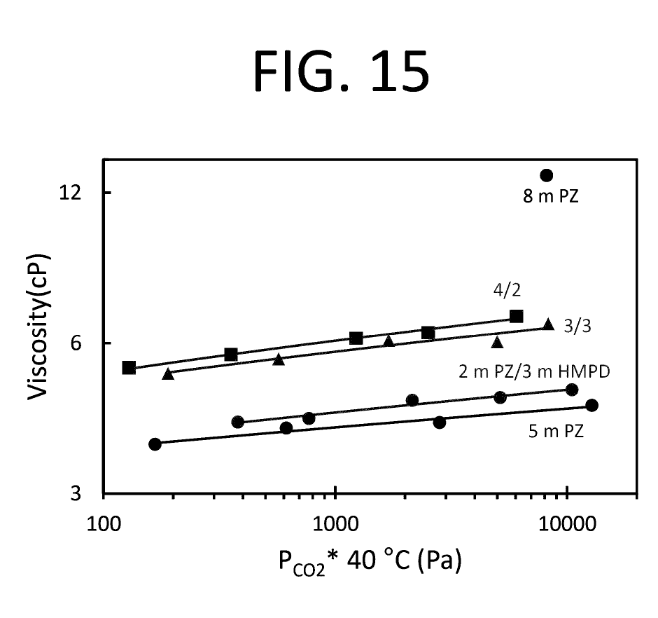

FIG. 15 shows the viscosity of loaded PZ/HMPD at 40° C., compared to 5 m PZ and 8 m PZ at the same CO₂ partial pressure. 2 m PZ/3 m HMPD has 10% higher viscosity than 5 m PZ. The viscosity of 3 m PZ/3 m HMPD and 4 m PZ/2 m HMPD is 50% higher than 5 m PZ, but is still only half of the viscosity of 8 m PZ. As expected, the higher CO₂ in these solutions leads to higher viscosity.

The CO₂ solubility in loaded 2 m PZ/3 m HMPD was measured from 20 to 100° C. using the WWC. CO₂ equilibrium partial pressure, P_{CO2} (Pa), was regressed using the following empirical model as a function of temperature, T (K), and CO₂ concentration, a (mol CO₂/kg H₂O+Amine), in the liquid phase.

$$ln {P}_{CO 2} = A + B * \frac{1}{T} + C * a + D * \frac{a}{T} + E * {a}^{2} + F * \frac{{a}^{2}}{T} \qquad ( 1 )$$

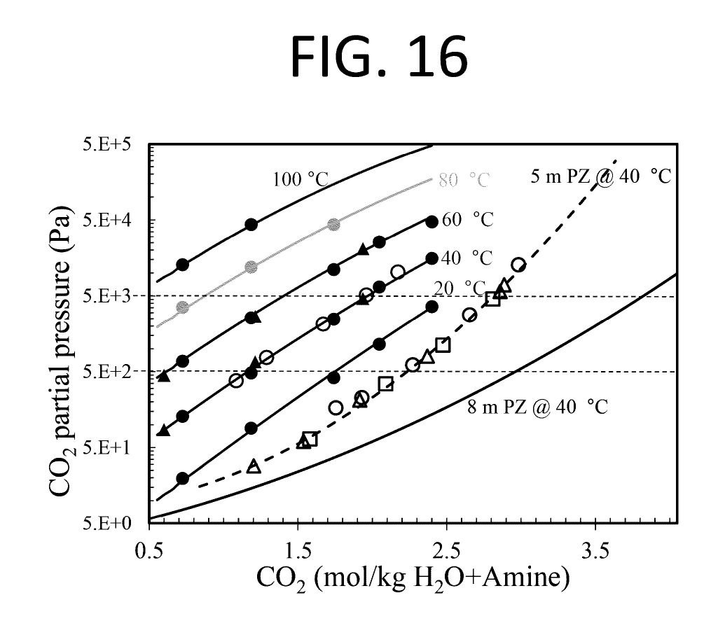

FIG. 16 shows the CO₂ solubility at different temperatures for 2 m PZ/3 m HMPD, compared to 5 m PZ and 8 m PZ. CO₂ solubility for 2 m PZ/3 m HMPD is consistently lower than for 5 m PZ and 8 m PZ at 40° C. Based on the difference in the equilibrium CO₂ partial pressure from 0.5 to 5 kPa at 40° C., the working capacity of 2 m PZ/3 m HMPD (0.79 mole per kg amines+water) is lower than that of 8 m PZ (0.86 mole per kg amines+water), but significantly higher than that of 5 m PZ (0.64 mole per kg amines+water), and that of 7 m MEA (0.50 mole per kg amines+water) (Li et al., 2013).

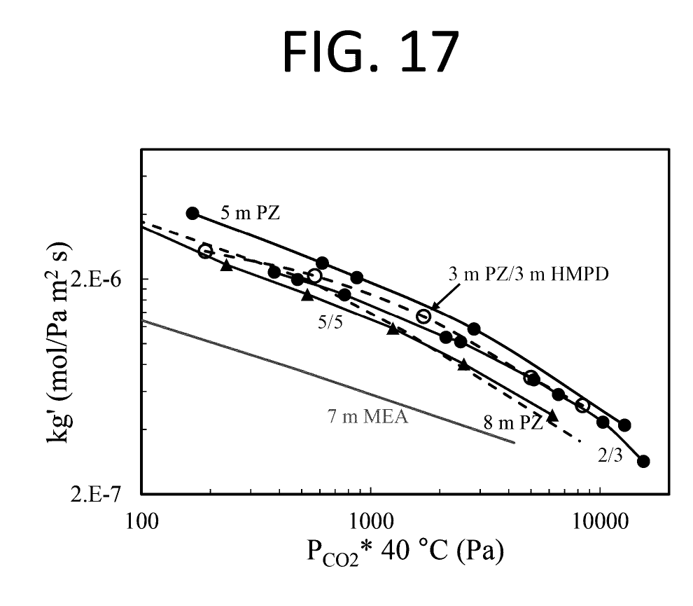

CO₂ absorption rate (kg′) into 2 m PZ/3 m HMPD and 3 m PZ/3 m HMPD is shown in FIG. 17. To compare their kg′ to that of 8 m PZ, 5 m PZ, and 7 m MEA on the same basis, the rate data are plotted against partial pressure of CO₂ instead of CO₂ loading. At lean loading, the two blends have a similar absorption rate to 8 m PZ, while at rich loading, they have an absorption rate comparable to 5 m PZ. The relatively low absorption rate of 2 m PZ/3 m HMPD, and 3 m PZ/3 m HMPD at lean loading compared to 5 m PZ is caused by the low concentration of PZ in these blends. Their relatively high absorption rate at rich loading compared to 8 m PZ is caused by their low viscosity.

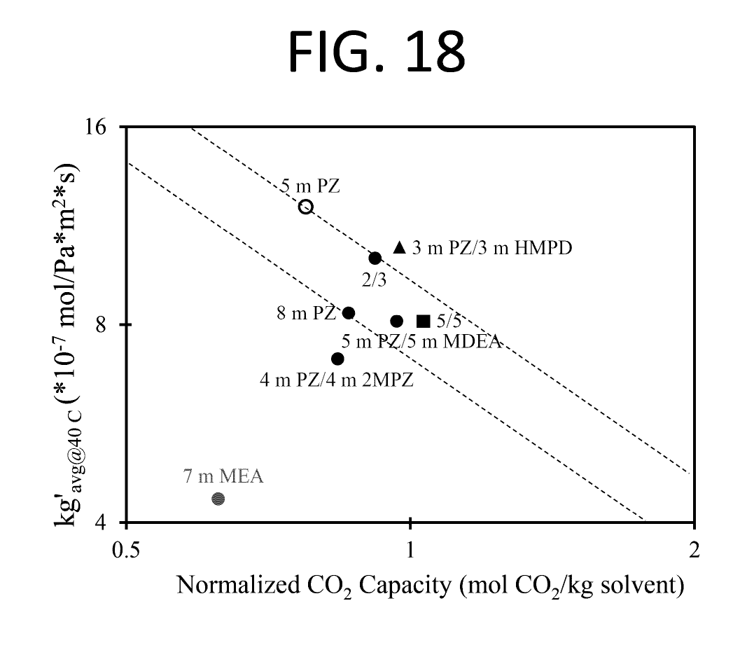

FIG. 18 shows the normalized CO₂ capacity and average absorption rate at 40° C. for PZ/HMPD, compared to 5 m PZ, 8 m PZ, 4 m PZ/4 m 2MPZ, 5 m PZ/5 m MDEA, and 7 m MEA. The normalized CO₂ capacity is defined in Equation 2 to consider the effect of viscosity on the heat exchanger cost in the process (Li et al., 2013).

$$Normalized CO 2 Capacity = \frac{Capacity}{{( {μ}_{{α}_{mid}} / {μ}_{8 m PZ} )}^{0.175}} \qquad ( 2 )$$

The average absorption rate is defined as equation 3 (Li et al., 2013).

$${k}_{{g}_{avg}}^{′} = \frac{{Flux}_{{CO}_{2} , LM}}{{( {P}_{{CO}_{2}} - {P}_{{CO}_{2}}^{*} )}_{LM}} = \frac{\frac{( {Flux}_{{CO}_{2} , top} - {Flux}_{{CO}_{2} , bottom} )}{Ln ( {Flux}_{{CO}_{2} , top} / {Flux}_{{CO}_{2} , bottom} )}}{\frac{( {P}_{{CO}_{2} , top} - {P}_{{CO}_{2} , lean}^{*} ) - ( {P}_{{CO}_{2} , bottom} - {P}_{{CO}_{2} , rich}^{*} )}{Ln ( \frac{{P}_{{CO}_{2} , top} - {P}_{{CO}_{2} , lean}^{*}}{{P}_{{CO}_{2} , bottom} - {P}_{{CO}_{2} , rich}^{*}} )}} \qquad ( 3 )$$

Normalized CO₂ capacity of 2 m PZ/3 m HMPD and 3 m PZ/3 m HMPD is comparable to 8 m PZ and 5 m PZ/5 m MDEA, but 20% higher than 5 m PZ, and 50% higher than 7 m MEA. CO₂ absorption rate of 2 m PZ/3 m HMPD and 3 m PZ/3 m HMPD are 15% lower than 5 m PZ, but 20% higher than 8 m PZ and 5 m PZ/5 m MDEA, and 2.3 times higher than 7 m MEA. Assuming that normalized capacity has the same effect as absorption rate on the overall CO₂ capture cost, 2 m PZ/3 m HMPD, and 3 m PZ/3 m HMPD will have a similar CO₂ capture cost to 5 m PZ, but lower than 8 m PZ, 5 m PZ/5 m MDEA, and 5 m PZ/5 m HMPD.

### Solvent Solubility

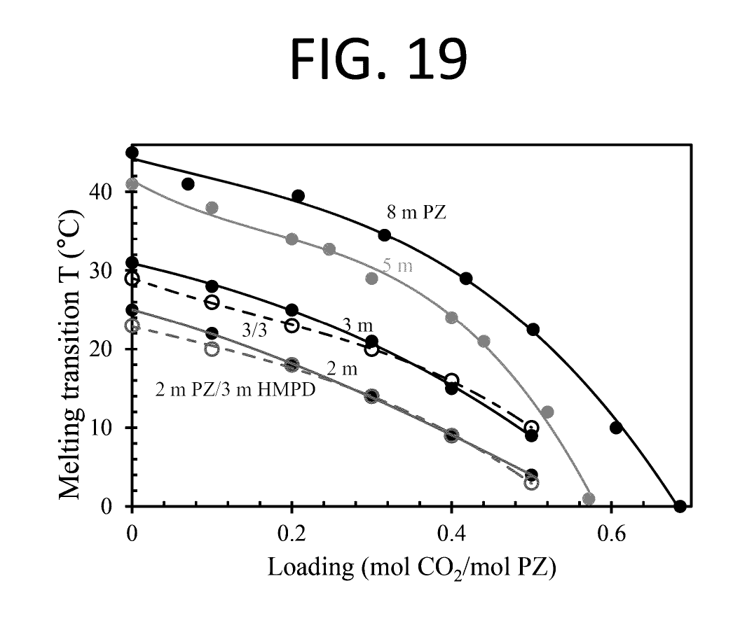

The melting transition temperature of 2 m PZ/3 m HMPD, and 3 m PZ/3 m HMPD over a range of CO₂ loading is given in FIG. 19, compared to the transition temperature for 2 m PZ, 3 m PZ, 5 m PZ, and 8 m PZ from Freeman (2011). Solid solubility of 2 m PZ/3 m HMPD and 3 m PZ/3 m HMPD is significantly better than 5 m PZ and 8 m PZ. At the lean loading giving CO₂ partial pressure of 100 Pa at 40° C., the melting transition temperature is 23° C. for 8 m PZ, 18° C. for 5 m PZ, 8° C. for 3 m PZ/3 m HMPD, and 5° C. for 2 m PZ/3 m HMPD.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

The use of the word “a” or “an” when used in conjunction with the term “comprising” in the claims and/or the specification may mean “one,” but it is also consistent with the meaning of “one or more,” “at least one,” and “one or more than one.” As used herein “another” may mean at least a second or more.

It is contemplated that any instance discussed in this specification can be implemented with respect to any method or composition of the invention, and vice versa. Furthermore, compositions of the invention can be used to achieve the methods of the invention.

Throughout this application, the term “about” is used to indicate that a value includes the inherent variation of error for the device, the method being employed to determine the value, or the variation that exists among the study subjects.

The use of the term “or” in the claims is used to mean “and/or” unless explicitly indicated to refer to alternatives only or the alternatives are mutually exclusive.

As used in this specification and claim(s), the words “comprising” (and any form of comprising, such as “comprise” and “comprises”), “having” (and any form of having, such as “have” and “has”), “including” (and any form of including, such as “includes” and “include”), or “containing” (and any form of containing, such as “contains” and “contain”) are inclusive or open-ended and do not exclude additional, unrecited elements or method steps.

What is claimed is:

1. An aqueous solvent comprising piperazine and a second amine compound selected from the group consisting of a tertiary morpholine, triethylenediamine, and 4-hydroxy-1-methyl piperidine.

2. The aqueous solvent of claim 1 wherein the tertiary morpholine comprises a hydroxyalkyl substituent group attached to a tertiary amino functional group.

3. The aqueous solvent of claim 1 wherein the piperazine and the second amine compound comprise from about 10 to about 60 weight % of the solvent and comprise an amine concentration from about 4 to 12 equivalents/kg water of the solvent.

4. The aqueous solvent of claim 1 where the tertiary morpholine is selected from the group consisting of hydroxyethylmorpholine, hydroxypropylmorpholine, and hydroxyisopropylmorpholine.

5. The aqueous solvent of claim 1 wherein the solvent is free of precipitate at a CO₂ loading of greater than 0.44 mol CO₂/mol alkalinity.

6. The aqueous solvent of claim 1 wherein the concentration of piperazine in the solvent is from about 0.50 molal to about 4.00 molal and the concentration of the second amine compound is from about 1.00 molal to about 7.00 molal.

7. The aqueous solvent of claim 1 wherein the solvent has a viscosity of about 9.90 cP to about 12.10 cP at a CO₂ loading of about 0.15 mol/mol alkalinity to about 0.3 mol/mol alkalinity, respectively, at a temperature of 40° C.

8. The aqueous solvent of claim 1 wherein the solvent possesses a working capacity of 0.79 mole per kg amines+water.

9. The aqueous solvent of claim 1 wherein the solvent is free of solidification at 150° C. for at least 10 days when loaded with CO₂ at 0.2 mol/mol alkalinity.

10. The aqueous solvent of claim 1, wherein the loss of piperazine and the second amine compound is 15% and 25%, respectively, at 150° C. for at least 10 days.

11. The aqueous solvent of claim 1 wherein the first order rate constant for thermal degradation of piperazine at 150° C. is less than or equal to 150 k₁×10⁻⁹ (s⁻¹).

12. The aqueous solvent of claim 1 wherein the first order rate constant for thermal degradation of the second amine at 150° C. is less than or equal to 350 k₁×10⁻⁹ (s⁻¹).

13. The aqueous solvent of claim 1 wherein the concentration of piperazine in the solvent is from about 0.50 molal to about 5.00 molal and the concentration of 4-hydroxy-1-methyl piperidine is from about 1.00 molal to about 5.00 molal.

14. A method comprising contacting an acidic gas with an aqueous solvent comprising piperazine and a second amine compound selected from the group consisting of a tertiary morpholine, triethylenediamine, and 4-hydroxy-1-methyl piperidine.

15. The method of claim 14 further comprising the step of obtaining the acidic gas from one of the group consisting of fossil fueled power plants, natural gas reservoirs, and industrial process gas sources.

16. The method of claim 14 wherein the tertiary morpholine is selected from the group consisting of hydroxyethylmorpholine, hydroxypropylmorpholine, and hydroxyisopropylmorpholine.

17. The method of claim 14 further comprising the step of thermally regenerating the solvent in a single process column and/or process vessel or a series of process columns and/or process vessels at above atmospheric pressure and at a temperature from about 120° C. to about 200° C.

18. The method of claim 14 further comprising the step of thermally regenerating the solvent in a simple stripper, single-stage flash, two stage flash, or advanced flash stripper.

19. The method of claim 14 comprising a maximum stripper operating temperature of 150 to 155° C., wherein the maximum stripper operating temperature is defined as the temperature which corresponds to an overall amine degradation rate of 2.9×10⁻⁸ s⁻¹.

20. The method of claim 14 wherein the concentration of piperazine in the solvent is from about 0.50 molal to about 5.00 molal and the concentration of 4-hydroxy-1-methyl piperidine is from about 1.00 molal to about 5.00 molal.
